(19) United States
(12) Patent Application Publication
(10) Pub. No.: US 2025/0119478 A1
(43) Pub. Date: Apr. 10, 2025

(54) INFORMATION PROCESSING METHOD, INFORMATION PROCESSING DEVICE, AND NON-TRANSITORY COMPUTER READABLE STORAGE MEDIUM

(71) Applicant: Panasonic Intellectual Property Corporation of America, Torrance, CA (US)

(72) Inventors: Koki TANAKA, Osaka (JP); Yuki MORIMITSU, Kanagawa (JP); Kenta MURAKAMI, Osaka (JP); Masafumi ISHIKAWA, Tokyo (JP)

(73) Assignee: Panasonic Intellectual Property Corporation of America, Torrance, CA (US)

(21) Appl. No.: 18/986,020

(22) Filed: Dec. 18, 2024

Related U.S. Application Data
(63) Continuation of application No. PCT/JP2022/044685, filed on Dec. 5, 2022.

(30) Foreign Application Priority Data
Jun. 24, 2022 (JP) 2022-101744

(51) Int. Cl. H04L 67/50; H04L 41/5061; H04L 67/125; H04L 67/51

(52) U.S. Cl. CPC H04L 67/535; H04L 41/5064; H04L 67/125; H04L 67/51

(57) ABSTRACT

An information processing method by a computer includes acquiring action information indicative of at least one of a device operation and a behavior of a user, estimating a plurality of traits of the user on the basis of the action information, determining a service to be performed to the user on the basis of the traits, and outputting service information indicative of the service.

### FIELD OF INVENTION

The present disclosure relates to a technique of determining a service to be performed to a user.

### BACKGROUND ART

There has been conventionally known a service of estimating, on the basis of a search history or a browsing history of the user in a cyberspace such as a website, an intention and a taste of the user, and providing the user with information such as an advertisement suitable for the intention and the taste of the user. Further, Patent Literature 1 discloses a technique of estimating a type of the characteristic tendency of the user on the basis of a use history of a device for processing a material.

However, no consideration can be seen in the conventional art about determination of a service to be performed to a user in accordance with a plurality of traits of the user which is estimated on the basis of a device operation or a behavior of the user.

Patent Literature 1: Japanese Patent No. 6294825

### SUMMARY OF THE INVENTION

The present disclosure has been worked out in order to solve the problem described above, and the object thereof is to provide an information processing method, an information processing device and a non-transitory computer readable storage medium which make it possible to determine a service to be performed to a user in accordance with a plurality of traits of the user which is estimated on the basis of a device operation or a behavior of the user.

An information processing method according to an aspect of the present disclosure is an information processing method by a computer, and includes acquiring action information indicative of at least one of a device operation and a behavior of a user, estimating a plurality of traits of the user on the basis of the action information, determining a service to be performed to the user on the basis of the traits, and outputting service information indicative of the service.

### BRIEF DESCRIPTION OF THE DRAWINGS

FIG. 1 is a diagram showing a general configuration of an information processing system according to an embodiment of the present disclosure.

FIG. 2 is a block diagram showing a configuration of an exemplary information processing device.

FIG. 3 is a flowchart showing an exemplary trait output process.

FIG. 4 is a table showing exemplary operation information.

FIG. 5 is a flowchart showing an exemplary trait estimation process.

FIG. 6 is a table showing exemplary trait information.

FIG. 7 is a table showing exemplary first rule information defining a relationship between one or more candidate traits and one or more feature groups indicative of features of operation to a device or an equipment.

FIG. 8 is a table showing exemplary first rule information defining a relationship between one or more candidate traits and one or more feature groups indicative of features of behavior.

FIG. 9 is a table showing exemplary relationships between traits of a target user and execution numbers of distinctive actions showing respective traits before an update.

FIG. 10 is a table showing exemplary relationships between traits of the target user and execution numbers of distinctive actions showing respective traits after an update.

FIG. 11 is a flowchart showing an exemplary service information output process.

FIG. 12 is a flowchart showing an exemplary service determination process.

FIG. 13 is a table showing exemplary second rule information.

FIG. 14 is a table showing exemplary information that associates trait information with second rule information.

FIG. 15 is a table showing exemplary third rule information.

FIG. 16 is a table showing a remaining part of the exemplary third rule information.

FIG. 17 is a table showing other exemplary information that associates trait information with second rule information.

FIG. 18 is a table showing exemplary fourth rule information.

FIG. 19 is a table showing exemplary fifth rule information.

### DETAILED DESCRIPTION

### Circumstances Which Led to the Present Disclosure

There has been conventionally known a service of estimating, on the basis of a search history or a browsing history of the user in a cyberspace such as a website, an intention and a taste of the user, and providing the user with information such as an advertisement suitable for the intention and the taste of the user. However, in this conventional technique, the estimation of the intention and the taste of the user is performed on the basis of information reflecting the intention and the taste of the user, actively input by the user, such as an input of a search keyword, a click on a product image, or the like. Therefore, an environment in which the user is invited to actively input information is required to adopt this conventional technique.

In this respect, Patent Literature 1 discloses a technique of estimating a type of a characteristic tendency of the user on the basis of use history of a device of the user in a situation where the user does not actively input information. However, no consideration can be seen in Patent Literature 1 about estimation of peculiar characteristic tendencies of the user on the basis of the use history of the device of the user.

Therefore, the conventional technique hardly enables determination of a service to be performed to the user on the basis of a plurality of traits of the user which is estimated on the basis of a device operation or a behavior of the user. For example, there is a case that the user has two traits “lazy” and “clumsy”. In this case, although the conventional technique enables the estimation of the one trait “lazy” of the user and the performance of an automatic control service of the device suitable for the trait to the user, the conventional technique hardly enables the performance of an automatic control service of the device which is suitable for the other trait “clumsy” of the user, too.

Accordingly, the present inventors have intensively studied a technique of determining a service to be performed to the user on the basis of traits of the user which are estimated on the basis of a device operation or a behavior of the user. As a result, the present inventors have worked out forms of the present disclosure described below.

(1) An information processing method according to an aspect of the present disclosure is an information processing method by a computer, and includes acquiring action information indicative of at least one of a device operation and a behavior of a user, estimating a plurality of traits of the user on the basis of the action information, determining a service to be performed to the user on the basis of the traits, and outputting service information indicative of the service.

In this configuration, traits of the user are estimated on the basis of the action information indicative of at least one of a device operation and a behavior of the user. Subsequently, a service to be performed to the user is determined on the basis of the traits. Therefore, this configuration makes it possible to determine a service to be performed to the user on the basis of traits of the user which are estimated on the basis of a device operation or a behavior of the user.

(2) In the information processing method recited in the above-mentioned (1), it may be appreciated that, in the determination of the service, a first category for specifying the service is determined on the basis of the traits, a second category associated with the first category is determined on the basis of the traits, and the service is determined on the basis of the first category and the second category.

In this configuration, the first category and the second category associated with the first category are determined on the basis of traits which are estimated on the basis of the action information indicative of at least one of a device operation and a behavior of the user. Subsequently, the service to be performed to the user is determined on the basis of the thus-determined first category and second category. Therefore, this configuration makes it possible to determine a service to be performed to the user on the basis of traits of the user which are estimated on the basis of a device operation or a behavior of the user.

(3) In the information processing method recited in the above-mentioned (2), it may be appreciated to further acquire information defining a relationship among a plurality of constituent traits, one or more first candidate categories, and one or more second candidate categories, wherein, in the determination of the first category, a first number denoting the number of traits that have the same content as the respective constituent traits with respect to each of the one or more first candidate categories is calculated, a first candidate category which has a greatest first number is specified among the one or more first candidate categories, and the specified first candidate category is determined as the first category, in the determination of the second category, a second number denoting the number of traits that have the same content as the respective constituent traits with respect to each of the one or more second candidate categories is calculated, a second candidate category which has a greatest second number is specified among the one or more second candidate categories, and the specified second candidate category is determined as the second category, in the determination of the service, rule information defining a relationship among one or more first categories, one or more second categories, and a plurality of candidate services is acquired, and the candidate service associated with the first category and the second category is specified among the candidate services, and the specified candidate service is determined as the service.

This configuration makes it possible to determine, as the service to be performed to the user, a candidate service associated with a first candidate category and a second candidate category that respectively have the greatest numbers of constituent traits having the same content as traits of the user.

(4) In the information processing method recited in the above-mentioned (2), it may be appreciated to further calculate an intensity of each of the traits on the basis of the action information; and acquire information defining a relationship among a plurality of constituent traits, one or more first candidate categories, and one or more second candidate categories, wherein, in the determination of the first category, a first trait having the greatest intensity is specified among the traits, the first candidate category associated with the constituent trait having the same content as the first trait is specified among the one or more first candidate categories, and the specified first candidate category is determined as the first category, in the determination of the second category, the trait whose intensity is next to the first trait among the traits is determined as the second trait, the second candidate category associated with the constituent trait having the same content as the second trait is specified among the one or more second candidate categories, and the specified second candidate category is determined as the second category, in the determination of the service, rule information defining a relationship among one or more first categories, one or more second categories, and a plurality of candidate services is acquired, and the candidate service associated with the first category and the second category is specified among the candidate services, and the specified candidate service is determined as the service.

This configuration makes it possible to determine, as the service to be performed to the user, a candidate service which is associated with a first trait having the greatest intensity and a second trait having the intensity next to the first trait among traits of the user.

(5) In the information processing method recited in the above-mentioned (3) or (4), it may be appreciated that the one or more first categories include any one of a service field to which each of the candidate services pertain, a type of each of the candidate services, a performance time of each of the candidate services, and a performance way of each of the candidate services, and the one or more second categories include any one of the service field, the type, the performance time, and the performance way that is different from the one or more first categories.

This configuration makes it possible to specify any two of a service field, a type, a performance time, and a performance way as the first category and the second category on the basis of traits of the user and determine a candidate service associated with the first category and the second category as the service to be performed to the user.

(6) In the information processing method recited in the above-mentioned (2), it may be appreciated to further calculate respective intensities of the traits on the basis of the action information, acquire information defining a relationship among one or more first traits, one or more device automatic controls, one or more second traits, and one or more fine controls included in each of the device automatic controls, wherein, in the determination of the first category, the first trait having the same content as each of the traits is specified among the one or more first traits, the device automatic control associated with the specified first trait is specified among the one or more device automatic controls, and the specified device automatic control is determined as the first category, in the determination of the second category, the second trait that is associated with the device automatic control determined as the first category and has the same as each of the traits is specified among the one or more second traits, the fine control associated with the specified second trait is specified among the one or more fine controls, and the specified fine control is determined as the second category, and in the determination of the service, an automatic control service of performing the fine control indicated by the second category included in the device automatic control indicated by the first category is determined as the service.

This configuration makes it possible to determine, as the service to be performed to the user, an automatic control service of performing a fine control that is associated with a second trait having the same content as each of the traits of the user and is included in a device automatic control that is associated with a first trait having the same content as each of the traits of the user.

(7) In the information processing method recited in the above-mentioned (3), it may be appreciated that the user includes a first user and a second user, in a case that the first user and the second user are in a common environment, the acquisition of the action information and the estimation of the traits are respectively executed about each of the first user and the second user, the first category and the second category are determined using a multiset of the traits estimated about the first user and the second user as the traits estimated about the user, and the determination of the service and the output of the service information are executed.

This configuration makes it possible to determine a service to be performed to the first user and the second user who are in a common environment on the basis of traits included in a multiset of the traits estimated about the first user and the second user who are in the environment.

(8) In the information processing method recited in the above-mentioned (4), the user may include a first user and a second user, in a case that the first user and the second user are in a common environment, the acquisition of the action information, the estimation of the traits, the calculation of intensities of the respective traits, the determination of the first category, the determination of the second category, and the determination of the service may be respectively executed about the first user and the second user, and the information processing method may further include acquiring information defining a relationship among one or more conflicting service groups each including two or more conflicting services and a plurality of avoidance manners for avoiding the conflicts, the avoidance manners including a first manner of selecting one of the two or more conflicting services and a second manner of merging the two or more conflicting services, extracting, when a multiset of the services determined for the first user and the second user includes a service group having the same content as the conflicting service group, the service group from the multiset, determining which a target avoidance manner that is an avoidance manner associated with the conflicting service group having the same as the service group is the first manner or the second manner, in a case that the target avoidance manner is the first manner, acquiring an intensity of the first trait of the user whom each of the two or more services included in the service group is provided to, selecting one service of the two or more services on the basis of the intensity of the first trait acquired about each of the two or more services, and outputting information indicative of the one service as the service information, in a case that the target avoidance manner is the second manner, acquiring an intensity of the second trait of the user whom each of the two or more services is provided to, and merging the two or more services on the basis of the intensity of the second trait acquired about each of the two or more services, and outputting information indicative of the merged service as the service information.

In the case that a multiset of services determined as the services to be respectively performed to the first user and the second user who are in the common environment includes two or more conflicting services, this configuration makes it possible to output information indicative of one service which enables the avoidance of the conflict between the two or more services as the service information indicative of the service to be performed to the user.

Specifically, in the case that the target avoidance manner associated with a conflicting service group having the same content as a service group indicating two or more services is determined to be the first manner, information indicative of one service selected among the two or more services on the basis of intensities of the first traits of the users whom each of the services is provided to can be output as the service information.

On the other hand, in the case that the target avoidance manner is determined to be the second manner, the two or more services are merged on the basis of intensities of the second traits of the users whom each of the two or more services is provided to, and information indicative of the merged service can be output as the service information.

(9) In the information processing method recited in the above-mentioned (8), in the case that the target avoidance manner is the first manner, in the selection of the one service, the service which is provided to the first trait having the greatest intensity may be selected among the two or more services as the one service.

In the case that the target avoidance manner is determined to be the first manner, this configuration makes it possible to output information indicative of one service which is provided to the first trait having the greatest intensity among the two or more services as the information indicative of the one service which enables the avoidance of the conflict between the two or more services.

(10) In the information processing method recited in the above-mentioned (8), it may be appreciated that, in the case that the target avoidance manner is the second manner, in the merger of the two or more services, a difference between intensities of any two of the second traits among the intensities of the second traits provided with the two or more services is calculated, and in a case that the difference is smaller than a predetermined value, the two or more services are merged as the merged service by averaging conflicting parameters among the two or more services, and in a case that the difference is equal to or greater than the predetermined value, the service which is provided to the second trait having the greatest intensity is determined as the merged service.

In the case that the target avoidance manner is determined to be the second manner, this configuration makes it possible to output information indicative of the service merged according to the difference between intensities of any two of second traits among intensities of the two or more services as the information indicative of the one service which enables the avoidance of the conflict between the two or more services.

Specifically, in the case that the difference is smaller than the predetermined value, the two or more services are merged as the merged service by averaging conflicting parameters among the two or more services, and the information indicative of the merged service can be output as the information indicative of the one service. On the other hand, in the case that the difference is equal to or greater than the predetermined value, the service which is provided to the second trait having the greatest intensity is determined as the merged service, and the information indicative of the merged service can be output as the information indicative of the one service.

(11) In the information processing method recited in any one of the above-mentioned (8) to (10), it may be appreciated, in a case that the service group is extracted, to further acquire a priority level assigned to each of the candidate services by each of one or more of the first user and the second user, determine whether the priority level is assigned to each candidate service being included in the candidate services and having the same content as each of the two or more services by the user to whom each of the services is provided, specify the service to which the highest priority level is assigned among one or more services when the priority level is determined to be assigned to the one or more services among the two or more services, and output the service information indicative of the specified service.

In the above-recited configuration, there is a case that a service group having the same content as a conflicting service group is extracted from a multiset of services which are determined as the services to be respectively provided to the first user and the second user who are in the common environment.

In this case, if a priority level is assigned to one or more services included in the service group by each of one or more of the first user and the second user, this configuration makes it possible to prioritize the will of each of the one or more users and output information indicative of the service to which the highest priority level is assigned among the one or more services as the information indicative of the one service which enables the avoidance of the conflict between the two or more services.

(12) In the information processing method recited in the above-mentioned (3) or (4), it may be appreciated to further acquire information defining a relationship between the constituent traits and one or more environments, acquire environment information indicative of an environment where the user is currently present and acquire one or more constituent traits associated with the environment indicated by the environment information among the one or more environments from the constituent traits, wherein, in the determination of the first category and the second category, one or more traits having the same content as the one or more constituent traits among the traits is used in place of the traits.

This configuration makes it possible to restrict the constituent traits to be used for the determination of the first category and the second category to one or more constituent traits associated with the environment where the user is currently present. This makes it possible to restrict the services to be determined on the basis of the first category and the second category to the service suitable for the one or more constituent traits associated with the environment where the user is currently present.

(13) In the information processing method recited in the above-mentioned (4), it may be appreciated that, in the output of the service information, request information requesting the user to send back information indicative of use or non-use of the service indicated by the service information is output together with the service information to an output device used by the user, the determination of the first category, the determination of the second category, the determination of the service, and the output of the service information are re-executed when the information indicative of the non-use of the service is returned from the output device, and at the specification of the second trait in the determination of the second category during the re-execution, the trait whose intensity is next to the second trait among the traits is determined as the second trait.

In this configuration, each time the information indicative of the non-use of a service indicated by the service information is returned from an output device, the information indicative of the service that is determined on the basis of the changed second category can be output to the output device as the service information.

(14) In the information processing method recited in the above-mentioned (13), it may be appreciated that, in the output of the service information, permission-denial request information requesting the user to send back information indicative of permission or denial of a succeeding output of the service information is further output to the output device, and when the information indicative of the non-use of the service is returned from the output device until the information indicative of the denial of the succeeding output of the service information is returned from the output device, the determination of the first category, the determination of the second category, the determination of the service, and the output of the service information are re-executed.

In this configuration, each time information indicative of the non-use of a service is returned, until information indicative of the denial of a succeeding output of service information is returned from an output device, information indicative of the service that is determined on the basis of the changed second category can be output to the output device as the service information.

(15) In the information processing method recited in the above-mentioned (3) or (4), it may be appreciated to further acquire information indicative of a plurality of used services used by the user in the past, wherein, in the output of the service information, the number of specific used services which are the used services having the same content as the candidate services associated with the determined first category in the rule information among the used services is further calculated, and in a case that the number of the specific used services is not less than a certain number, information suggesting a suspension of the use of the specific used service is output together with the service information to an output device used by the user.

This configuration makes it possible to suggest to a user who used the certain number or more of specific used services having the same content as the candidate services associated with the first category in the past that the use of the certain number or more of specific used services is suspended.

(16) In the information processing method recited in the above-mentioned (3) or (4), it may be appreciated to further acquire information indicative of a plurality of used services used by the user in the past and respective use frequencies of the used services, wherein, in the output of the service information, the number of specific used services which are the used services having the same content as the candidate services associated with the determined first category in the rule information among the used services may be further calculated, and in a case that the number of the specific used services is not less than a certain number, information which suggests suspending the use of a specific used service having the lowest use frequency among the certain number or more of specific used services and using the service indicated by the service information may be output together with the service information to an output device used by the user.

This configuration makes it possible to suggest to a user who used the certain number or more of specific used services having the same content as the candidate services associated with the first category in the past that the use of a specific used service having the lowest use frequency among the certain number or more of specific used services is suspended and a service indicated by the service information is used.

(17) An information processing device according to another aspect of the present disclosure includes an acquisition part that acquires action information indicative of at least one of a device operation and a behavior of a user, an estimation part that estimates a plurality of traits of the user on the basis of the action information, a determination part that determines a service to be performed to the user on the basis of the traits, and an output part that outputs service information indicative of the service.

In this configuration, the same advantageous effects as the information processing method recited in the aforementioned (1) can be obtained.

(18) In the information processing device recited in the aforementioned (17), it may be appreciated that the determination part determines a first category for specifying the service on the basis of the traits, determines a second category associated with the first category on the basis of the traits, and determines the service on the basis of the first category and the second category.

In this configuration, the same advantageous effects as the information processing method recited in the aforementioned (2) can be obtained.

(19) A non-transitory computer readable storage medium according to still another aspect of the present disclosure is a non-transitory computer readable storage medium storing a program which causes a computer to function as an acquisition part that acquires action information indicative of at least one of a device operation and a behavior of a user, an estimation part that estimates a plurality of traits of the user on the basis of the action information, a determination part that determines a service to be performed to the user on the basis of the traits, and an output part that outputs service information indicative of the service.

In this configuration, the same advantageous effects as the information processing method recited in the aforementioned (1) can be obtained.

(20) In the non-transitory computer readable storage medium recited in the aforementioned (19), it may be appreciated that the determination part determines a first category for specifying the service on the basis of the traits, determines a second category associated with the first category on the basis of the traits, and determines the service on the basis of the first category and the second category.

In this configuration, the same advantageous effects as the information processing method recited in the aforementioned (2) can be obtained.

The present disclosure may be implemented also as a system which operates in accordance with the program. It is needless to say that the computer program may be distributed via a computer-readable non-transitory recording medium such as a CD-ROM or a communication network such as Internet.

In addition, each of the embodiments described below shows a specific example of the present disclosure. The numerical values, shapes, constituent elements, steps, order of steps, and the like shown in the following embodiments are merely examples, and are not intended to delimit the present disclosure. Also, among the constituent elements in the following embodiments, constituent elements not recited in the independent claims representing the broadest concepts are described as optional constituent elements. In all the embodiments, the respective contents may also be combined.

### Embodiment

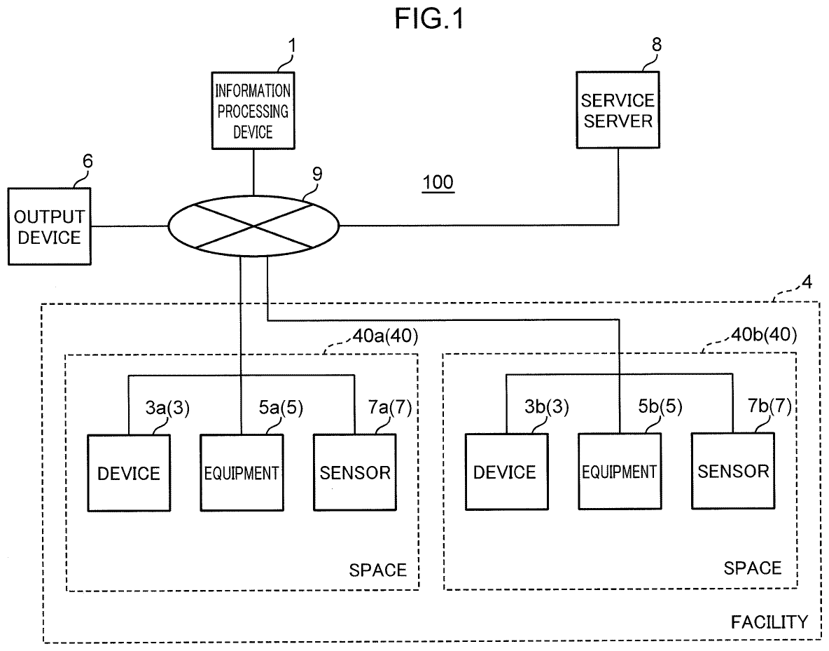

Hereinafter, an embodiment of the present disclosure will be described with reference to the drawings. FIG. 1 is a diagram showing a general configuration of an information processing system 100 according to an embodiment of the present disclosure. The information processing system 100 includes a plurality of devices 3, equipment (apparatuses) 5, and sensors 7, an output device 6, and an information processing device 1 which are provided in a facility (environment) 4.

The devices 3, the equipment 5, the sensors 7, and the information processing device 1 are mutually communicably connected via a network 9. The network 9 is a public communication network such as Internet. The network 9 may be a local area network. The devices 3, the equipment 5, and the sensors 7 may be mutually communicably connected via a local network in the facility 4.

The facility 4 is divided into a plurality of spaces (environments) 40. Some of the spaces 40 are provided with a plurality of devices 3, equipment 5, and sensors 7. FIG. 1 shows an example in which the facility 4 is divided into a first space 40a and a second space 40b, the first space 40a is provided with a device 3a, an equipment 5a, and a sensor 7a, and the second space 40b is provided with a device 3b, an equipment 5b, and a sensor 7b.

The facility 4 is, for example, a dwelling. The dwelling may be an apartment or may be an independent house. In a case that the facility 4 is a dwelling, the space 40 is, for example, a living room, a dining room, a kitchen, an LDK (a living-dining-kitchen), a western style room, a Japanese style room, a corridor, a toilet, an entrance, a bath, or the like. The LDK is a space that is adapted for a living room, a dining room, and a kitchen. Further, the space 40 may include, for example, a first floor and a second floor. Alternatively, the entire dwelling may be a single space 40.

Alternatively, the facility 4 may be an office. In a case that the facility 4 is an office, the space 40 is, for example, an office room, a conference room, an office kitchenette, a drawing room, a lobby, a corridor, a toilet, or the like. Further, the space 40 may include, for example, a first floor and a second floor. Alternatively, the entire office may be a single space 40.

The device 3 is an electronic device freely arrangeable in the facility 4, such as a rice cooker, a washing machine, a refrigerator, a microwave oven, and a cleaning robot. The device 3 is operated via a switch incorporated in the device 3 or a remote controller. The equipment 5 is an electronic apparatus such as an electronic lock, an air conditioner, a photovoltaic power apparatus or the like that is installed at a predetermined position in the facility 4. The equipment 5 is operated via a switch incorporated in the equipment 5 or a remote controller.

The device 3 and the equipment 5 do not include an information processing device such as a personal computer, a smartphone, and a tablet device. The operation to the device 3 and the equipment 5 does not include an operation involving a user's active input of information reflecting an intention or taste thereof, e.g., an input of a search keyword, or a click on a product image.

When operated by a user, the device 3 and the equipment 5 send information concerning the operation (hereinafter, operation information) to the information processing device 1 via the network 9.

The operation information includes a date and time (hereinafter, operation date and time) when the device 3 and the equipment 5 were operated, identification information (hereinafter, user ID) of the user who operated the device 3 and the equipment 5, identification information (hereinafter, device ID) of the device 3 and the equipment 5, information (hereinafter, operation item information) indicative of details on the operations to the device 3 and the equipment 5. The operation information sent from the device 3 and the equipment 5 may not include a user ID of the user who operated the device 3 and the equipment 5.

The operation item information includes information indicative of a condition (hereinafter, condition information) of the device 3 and the equipment 5 when being operated, information (hereinafter, setting information) set by the operation to the device 3 and the equipment 5, and information (hereinafter, function information) indicative of a function executed by the operation to the device 3 and the equipment 5.

The sensor 7 periodically detects information concerning the space 40 provided with the sensor 7. The sensor 7 sends information (hereinafter, sensor information) including detected information (hereinafter, detection information), a date and time (hereinafter, detection date and time) when the detected information was detected, and identification information (hereinafter, sensor ID) of the sensor 7 to the information processing device 1 via the network 9. The sensor 7 includes a camera, a microphone, a radio wave sensor, and a human sensing sensor.

The camera captures an image of the space 40 and sends sensor information including image data indicative of the captured image as the detection information. The microphone collects sound generated in the space 40 and sends sensor information including audio data indicative of the collected sound as the detection information. The radio wave sensor detects a location and a shape of a person who is present in the space 40 on the basis of an intensity of radio waves and sends sensor information including information indicative of the detected location and shape of the person as the detection information. The human sensing sensor is, for example, an infrared sensor and a beacon sensor, and detects whether a person is present in the space 40. When detecting the presence of a person in the space 40, the human sensing sensor sends the sensor information including information indicative of the location of the person as the detection information.

The output device 6 is mutually communicably connected to the information processing device 1 via the network 9. The output device 6 outputs information specified by the information processing device 1 via the network 9. The output device 6 includes a display, a speaker, and a controller.

The display is, for example, a display unit provided on a television receiving set, or a personal computer arranged in the facility 4. The display is not limited thereto and may be included in a mobile terminal which can be brought out of the facility 4, such as a smartphone and a tablet terminal, or may be included in the device 3 and the equipment 5. The display shows a still image or a moving image specified by the information processing device 1.

The speaker is, for example, a smart speaker arranged in the facility 4. The speaker is not limited thereto and may be included in a mobile terminal which can be brought out of the facility 4, such as a smartphone and a tablet terminal, or may be included in the device 3 and the equipment 5. The speaker outputs audio indicative of information specified by the information processing device 1.

The controller is, for example, a home controller or an edge server arranged in the facility 4. The controller is not limited thereto and may be a mobile terminal which can be brought out of the facility 4 such as a smartphone and a tablet terminal. The controller is further connected to the device 3, the equipment 5, and the sensor 7 via the network 9 or wirelessly communicably without using the network 9. The controller outputs information (hereinafter, control information) concerning a control of the device 3, the equipment 5, and the sensor 7 which is input by an operation of the user or is specified by the information processing device 1 to the device 3, the equipment 5, and the sensor 7. The device 3, the equipment 5, and the sensor 7 execute various functions in accordance with the control information. The controller thus remotely controls the device 3, the equipment 5, and the sensor 7.

The information processing device 1 includes a cloud server, a personal computer, and the like. The information processing device 1 may use an edge server provided in the facility 4. The information processing device 1 is mutually communicably connected to an external service server 8 via the network 9.

The service server 8 includes a cloud server and a personal computer. The service server 8 performs a service requested by the information processing device 1 via the network 9. The service to be performed by the service server 8 includes a service of forwarding information specified by the information processing device 1 to an unillustrated data base and/or external service server, a service of acquiring, from the unillustrated data base and/or external service server, the information specified by the information processing device 1 and returning it thereto.

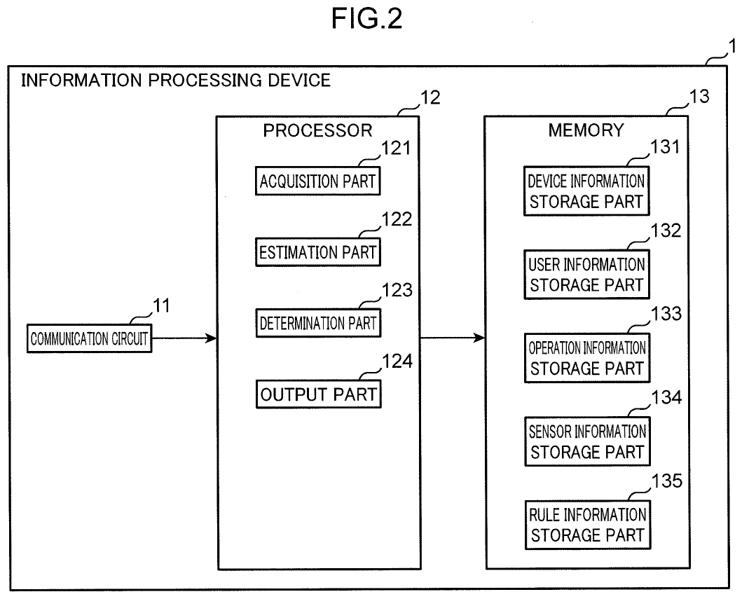

Hereinafter, detailed description will be made about the information processing device 1. FIG. 2 is a block diagram showing a configuration of an exemplary information processing device 1. The information processing device 1 includes a communication circuit 11, a processor 12, and a memory 13.

The communication circuit 11 is a communication interface circuit adapted to a communication system by use of the network 9, e.g., Ethernet (trademark). The communication circuit 11 connects the information processing device 1 to the network 9. The communication circuit 11 outputs various information which is received via the network 9 to the processor 12. Further, under the control of the processor 12, the communication circuit 11 sends various information to an external device via the network 9.

The processor (computer) 12 has, for example, a CPU. The processor 12 stores in an operation information storage part 133 to be described later operation information which is received by the communication circuit 11 from a device 3 and an equipment 5 via the network 9. Further, the processor 12 stores in a sensor information storage part 134 to be described later sensor information which is received by the communication circuit 11 from the sensor 7 via the network 9.

Further, the processor 12 functions as an acquisition part 121, an estimation part 122, a determination part 123, and an output part 124. The acquisition part 121 to the output part 124 may be accomplished by an execution of a predetermined program stored in the memory 13 by the processor 12 or may be accomplished by a dedicated hardware circuit.

The memory 13 is composed of a storage device, e.g., a hard disk drive and a solid-state drive. The memory 13 includes a device information storage part 131, a user information storage part 132, the operation information storage part 133, the sensor information storage part 134, and a rule information storage part 135. The device information storage part 131 to the rule information storage part 135 are not limited to the provision in the memory 13 but may be provided in an external storage device which the processor 12 can access using the communication circuit 11 via the network 9.

The device information storage part 131 stores information (hereinafter, device information) concerning the device 3, the equipment 5, and the sensor 7. Specifically, the device information concerning the device 3 and the equipment 5 includes identification information (hereinafter, space ID) of the space 40 provided with the device 3 and the equipment 5, the device ID of the device 3 and the equipment 5, an address indicating a destination for a control information transmission to the device 3 and the equipment 5, functions of the device 3 and the equipment 5, a use start period of expendable parts used by the device 3 and the equipment 5, and a condition (normal, anomalous) of the device 3 and the equipment 5. The device information concerning the sensor 7 includes a space ID of the space 40 provided with the sensor 7 and a sensor ID of the sensor 7.

The user information storage part 132 stores information (hereinafter, user information) concerning each of a plurality of users of the information processing system 100. Specifically, the user information includes a user ID of the user, information (hereinafter, attribute information) concerning an attribute of the user, and information (hereinafter, trait information) indicative of a trait of the user.

The attribute information includes, for example, an address, an age, a gender, a group being part of, and a role in the group of the user. The group includes, for example, a family and a department or a section of a company. The role includes, for example, father, mother, son, daughter, department director, section director, and the like.

The trait information includes a trait of the user and an intensity thereof. Traits of the user include one or more constituent traits. Constituent traits include, for example, negligent, meticulous, spendthrift, thrifty, well-regulated, irregular, tidy, untidy, nervous, loner, communicative, and the like.

The user information storage part 132 further stores reference data. The reference data is used to collate with detection information included in the sensor information for the purposes such as identifying the user who is in the space 40 provided with a sensor 7 and identifying the user who has operated the device 3 and the equipment 5 provided in the same space 40 provided with the sensor 7. Specifically, the reference data includes various data indicative of particulars of the user, e.g., image data indicative of a photographed image of a face or a full-length of the user, audio data indicative of a voice of the user, shape data indicative of a shape of the user, and a user ID of the user.

Further, the user information storage part 132 stores information peculiar to a user, e.g., a to-do list, a schedule, a vital data, an ongoing subscription service, and a preferred external service of the user, identification information of the output device 6 used by the user, and an IP address of the output device 6.

The operation information storage part 133 stores operation information received by the communication circuit 11 from the device 3 and the equipment 5 via the network 9.

The sensor information storage part 134 stores sensor information received by the communication circuit 11 from the sensor 7 via the network 9.

The rule information storage part 135 stores information indicative of various rules used by the processor 12 for various processing. Details on the information stored in the rule information storage part 135 will be described later.

### Flow of Trait Output Process

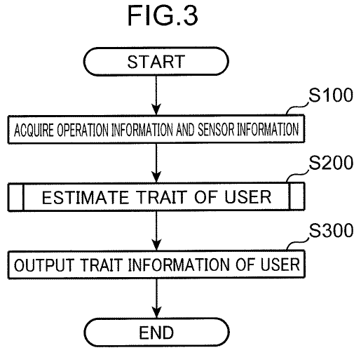

Hereinafter, a flow of the trait output process executed by the information processing device 1 will be described. The trait output process is a process of estimating a trait of a user of the information processing system 100 on the basis of operation information and sensor information and outputting trait information of the user. FIG. 3 is a flowchart showing an exemplary trait output process. The trait output process is executed, for example, every predetermined period, e.g., every day, every week, or every month. However, the process is not limited thereto. The trait output process may be executed each time operation information is acquired by the processor 12.

First, in Step S100, after completion of a previous trait output process, the acquisition part 121 acquires operation information stored in the operation information storage part 133 and sensor information stored in the sensor information storage part 134.

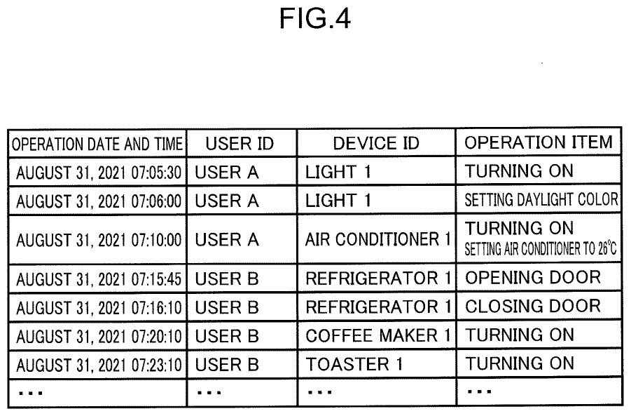

FIG. 4 is a table showing exemplary operation information. For example, FIG. 4 shows operation information acquired in Step S100 of a trait output process which has started at 6 o'clock on Sep. 1, 2021, after the completion of a previous trait output process which started at 6 o'clock on Aug. 31, 2021. The operation information indicates, for example, that a user whose user ID is “User A” executed an operation of turning on a device 3 whose device ID is “Light 1” at 07:05:30 on Aug. 31, 2021.

As described above, there is a case that no user ID of the user who operated the device 3 or equipment 5 is included in the operation information stored in the operation information storage part 133. In this case, the acquisition part 121 collates sensor information including a detection date and time coinciding with an operation date and time included in the operation information. The coincidence includes an agreement in a certain permissible range. The same is done in the description hereinafter. The acquisition part 121 collates the detection information included in the sensor information with the reference data stored in the user information storage part 132 and determines the user who operated the device 3 or equipment 5 in the space 40 indicated by the detection information. The acquisition part 121 acquires the user ID of the identified user as the user ID included in the operation information.

Next, in Step S200, the processor 12 takes each of the users associated with one or more user IDs included in the operation information acquired in Step S100 as the target, and executes a process (hereinafter, trait estimation process) of estimating a trait of a user who is a target (hereinafter, target user) to be estimated. In the trait estimation process, the trait information of the target user stored in the user information storage part 132 is updated. Details on the trait estimation process will be described later.

Next, in Step S300, the output part 124 outputs the trait information of each target user. For example, in Step S300, the output part 124 sends (outputs) the trait information of each user updated in Step S200 to a predetermined external device, e.g., an output device 6 (FIG. 1) using a communication circuit 11.

### Flow of Trait Estimation Process

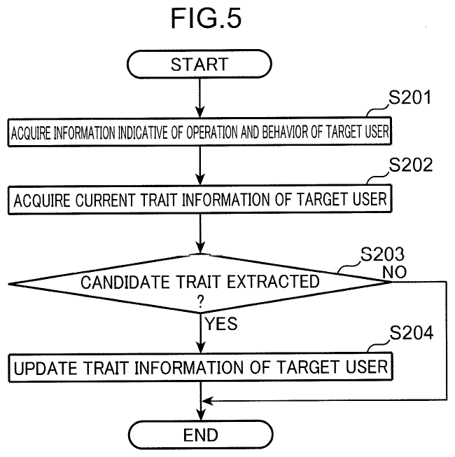

Hereinafter, details on the trait estimation process in Step S200 will be described. FIG. 5 is a flowchart showing an exemplary trait estimation process. For example, in a case that the operation information shown in FIG. 4 is acquired in Step S100, the processor 12 executes a trait estimation process of estimating a trait of the user who has user ID “User A” included in the operation information and is the target user. Further, the processor 12 executes a trait estimation process of estimating a trait of a user who has user ID “User B” included in the operation information and is the target user.

First, in Step S201, the acquisition part 121 acquires operation information (action information) indicative of an operation (device operation) of the device 3 or equipment 5 of the target user and sensor information (action information) indicative of a behavior of the target user in a period after the completion of the previous trait output process.

Specifically, in Step S201, the acquisition part 121 acquires a piece of operation information including a user ID of the target user from the operation information acquired in Step S100. Hereinafter, a piece of the operation information indicative of an operation to the device 3 or equipment 5 of the target user which is acquired in Step S201 is called as operation history information.

The acquisition part 121 acquires a sensor ID of the sensor 7 provided in the space 40 provided with the device 3 or equipment 5 whose device ID is included in the operation history information with reference to the device information stored in the device information storage part 131. The acquisition part 121 acquires a piece of sensor information including the sensor ID and also including a detection date and time that coincides with an operation date and time included in the operation history information from the sensor information acquired in Step S100. Hereinafter, a piece of the sensor information indicative of a behavior of the target user which is acquired in Step S201 is called as behavior history information.

Next, in Step S202, the estimation part 122 acquires current trait information of the target user. Specifically, the estimation part 122 acquires trait information of the target user stored in the user information storage part 132.

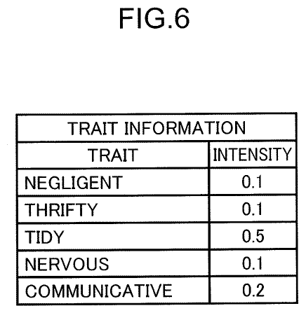

FIG. 6 is a table showing exemplary trait information. The trait information includes a plurality of traits and the intensity of each of the traits. The trait information shown in FIG. 6 indicates that the target user displays five traits, i.e., “negligent”, “thrifty”, “tidy”, “nervous”, and “communicative”, and that the respective intensities of the traits are “0.1”, “0.1”, “0.5”, “0.1”, and “0.2”.

In this embodiment, a greater value of intensity indicates a greater intensity with which the target user displays a trait. The same can be said about the description hereinafter. In other words, the trait information shown in FIG. 6 indicates that the target user displays the trait “tidy” most intensively.

Next, in Step S203, the estimation part 122 extracts candidate traits estimated to be traits of the target user on the basis of the operation history information and the behavior history information acquired in Step S201.

Specifically, in Step S203, the estimation part 122 acquires from the rule information storage part 135 first rule information defining a relationship between one or more candidate traits which may be traits of the target user and one or more feature groups indicative of features of an operation to the device 3 or equipment 5, or a behavior.

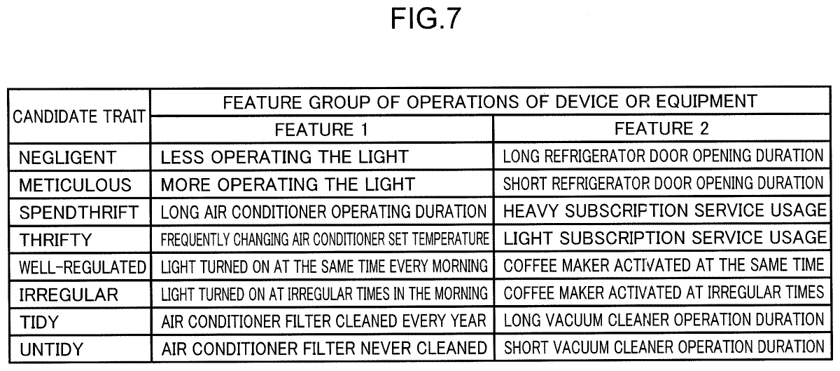

FIG. 7 is a table showing exemplary first rule information defining a relationship between one or more candidate traits and one or more feature groups each indicative of features of operations of a device 3 or equipment 5. In the first rule information shown in FIG. 7, eight candidate traits are associated with respective feature groups each indicative of two features of operations of the device 3 or equipment 5 of a user who has the candidate traits as the constituent traits.

For example, in the first rule information shown in FIG. 7, the candidate trait “negligent” is associated with a feature group indicative of a feature “less operating the light” concerning the operation to the light and a feature “long refrigerator door opening duration” concerning the operation to the refrigerator of the user who has the candidate trait “negligent” as the constituent trait.

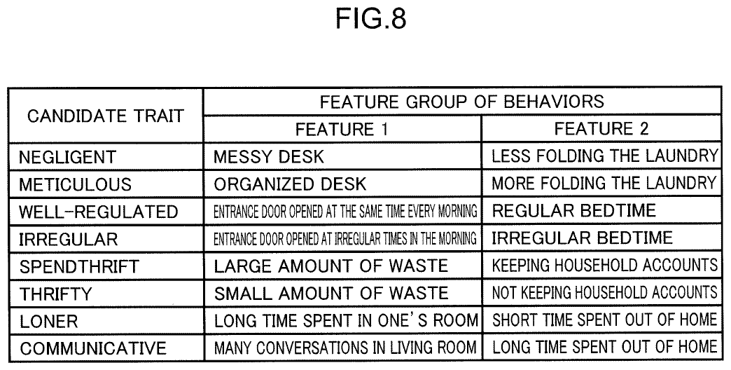

FIG. 8 is a table showing exemplary first rule information defining a relationship between one or more candidate traits and one or more feature groups indicative of features of behaviors. In the first rule information shown in FIG. 8, eight candidate traits are associated with respective feature groups each indicative of two features of behaviors of a user who has the candidate traits as the constituent traits.

For example, in the first rule information shown in FIG. 8, the candidate trait “negligent” is associated with a feature group indicative of a feature of behavior “messy desk” and a feature of behavior “less folding the laundry” of the user who has the candidate trait “negligent” as the constituent trait.

The number of features included in a feature group in the first rule information is not limited to two but may be one, or three or more. However, the number of features included in a feature group in the first rule information is preferably two or more since a single feature of an operation to the device 3 or equipment 5, or a behavior of a user does not always evidently reflect an intention and a taste of the user.

Next, the estimation part 122 extracts a candidate trait estimated to be a trait of the target user on the basis of the operation history information and the behavior history information which are acquired in Step S201 with reference to the first rule information.

Specifically, the estimation part 122 determines whether the operations of the device 3 or equipment 5 of the target user indicated by the operation history information include the operations of the device 3 or equipment 5 showing one or more feature groups included in the first rule information with reference to the first rule information shown in FIG. 7.

Inclusion of operations of the device 3 or equipment 5 showing the feature group means that the numbers of executions of all the operations of the device 3 or equipment 5 respectively showing the one or more features included in the feature group are one or more. The information indicating an operation to the device 3 or equipment 5 showing each feature is stored in the rule information storage part 135. The estimation part 122 executes the determination with reference to the information.

When it is determined that operations of a device 3 or equipment 5 showing one or more feature groups are included, the estimation part 122 specifies one or more candidate traits associated with the one or more feature groups in the first rule information. The estimation part 122 estimates the specified one or more candidate traits as the traits of the target user and extracts the one or more candidate traits.

For example, in a case that the operations of the device 3 or equipment 5 of the target user indicated by the operation history information include one or more executions of the operation to the light showing the feature “less operating the light” included in the feature group associated with the candidate trait “negligent” included in the first rule information shown in FIG. 7 and the operations of the device 3 or equipment 5 of the target user indicated by the operation history information also includes one or more executions of the operation to the refrigerator showing the feature “long refrigerator door opening duration” included in the same feature group, the estimation part 122 estimates the candidate trait “negligent” associated with the feature group in the first rule information to be a trait of the target user and extracts the candidate trait “negligent”.

The operation to the light showing the feature “less operating the light” indicates, for example, an operation of turning on and off the light a predetermined number of times (e.g., two) or less per day. However, the operation is not limited thereto. The operation may be a set of operations in which a ratio of the number of turning on and off times of the light to the number of user absenting times of the space 40 provided with the light is a predetermined value (e.g., 0.7) or smaller. The number of user absenting times of the space 40 provided with the light may be acquired with reference to the device information stored in the device information storage part 131 and behavior history information including a detection date and time coinciding with the operation date and time included in the operation history information.

On the other hand, the operation to the refrigerator showing the feature “long refrigerator door opening duration” indicates, for example, an operation in which an average refrigerator door opening duration per day is a predetermined duration or more. However, the definition is not limited thereto. The operation may be a set of operations in which a ratio of the number of alarming times for excessive refrigerator door opening duration after a door opening of the refrigerator by the user to the number of door opening times of the refrigerator by the user is a predetermined value (e.g., 0.3) or more

Similarly, with reference to the first rule information shown in FIG. 8, the estimation part 122 determines whether behaviors of the target user indicated by the behavior history information include behaviors showing one or more feature groups included in the first rule information.

Inclusion of execution numbers of behaviors showing a feature group means that the numbers of executions of all the behaviors respectively showing one or more features included in the feature group are one or more. The information indicating a behavior showing each feature is stored in the rule information storage part 135. The estimation part 122 executes the determination with reference to the information.

When it is determined that behaviors showing one or more feature groups are included, the estimation part 122 specifies one or more candidate traits associated with the one or more feature groups in the first rule information. The estimation part 122 estimates the specified one or more candidate traits to be traits of the target user and extracts the one or more candidate traits.

For example, in a case that the behaviors of the target user indicated by the behavior history information include one or more executions of the behavior showing the feature “messy desk” included in the feature group associated with the candidate trait “negligent” included in the first rule information shown in FIG. 8 and the behaviors of the target user indicated by the behavior history information also include one or more executions of the behavior showing the feature “less folding the laundry” included in the same feature group, the estimation part 122 estimates the candidate trait “negligent” associated with the feature group in the first rule information to be a trait of the target user and extracts the candidate trait “negligent”.

The behavior showing the feature “messy desk” indicates, for example, a behavior according to which a predetermined number of objects or more are left on a desk for a certain duration or more. The behavior showing the feature “less folding the laundry” indicates, for example, a behavior in which a ratio of the number of wearing times of unfolded clothes to the number of wearing times of clothes is a predetermined value or more.

In Step S203, the estimation part 122 may omit the extraction of a candidate trait based on one of the operation history information and the behavior history information which are acquired in Step S201.

In a case that no candidate trait is extracted in Step S203 (NO in Step S203), the trait estimation process ends without an update of the trait information which is acquired in Step S202.

On the other hand, in a case that one or more candidate traits estimated to be traits of the target user are extracted in Step S203 (YES in Step S203), in Step S204, the estimation part 122 updates the trait information acquired in Step S202, and ends the trait estimation process.

Specifically, in a case that the candidate trait extracted in Step S203 is not yet included in the trait information acquired in Step S202, in Step S204, the estimation part 122 adds the candidate trait to the trait information. Further, the estimation part 122 updates (sets) an intensity of each of the traits included in the trait information, and updates the trait information of the target user stored in the user information storage part 132 based on the updated trait information.

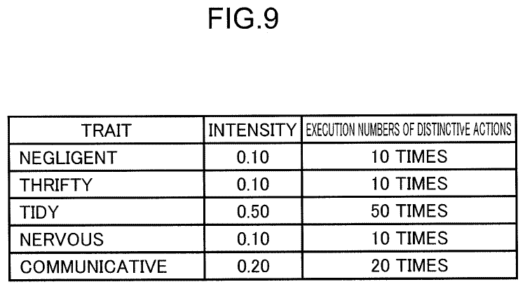

Hereinafter, details on Step S204 will be described. FIG. 9 is a table showing exemplary relationships between traits of a target user and execution numbers of distinctive actions showing respective traits before an update. FIG. 9 shows exemplary relationships between the trait information of the target user shown in FIG. 6 and execution numbers of the distinctive actions showing respective traits included in the trait information. The execution numbers of the distinctive actions showing respective traits are stored in the user information storage part 132 in association with the trait information.

The distinctive actions showing the respective traits indicate operations of a device 3 or equipment 5 or behaviors showing a feature group associated with a candidate trait having the same content as each trait in the first rule information. For example, distinctive actions showing the trait “negligent” indicate an operation to the light and an operation to the refrigerator respectively showing two features “less operating the light” and “long refrigerator door opening duration” which are associated with the candidate trait “negligent” having the same content as the trait “negligent” in the first rule information (FIG. 7). Further, distinctive actions showing the candidate trait “negligent” indicate behaviors respectively showing two features “messy desk” and “less folding the laundry” which are associated with the candidate trait “negligent” in the first rule information (FIG. 8).

The execution number of the distinctive action showing the trait “negligent” included in the trait information is the smallest value in the respective execution numbers of the operation to the light and the operation to the refrigerator, which are the distinctive actions in the operation to the device 3 or equipment 5 by the target user indicated by the operation history information, and the execution numbers of the behaviors, which are the distinctive actions in the behavior of the target user indicated by the behavior history information.

In other words, the execution number of the distinctive action showing each trait is the smallest value in the execution numbers of operations of a device 3 or equipment 5 and behaviors showing each feature included in a feature group associated with a candidate trait having the same content as each of the traits. However, the process is not limited thereto. The execution number of the distinctive action showing each trait may be an average value of or the largest value in the execution numbers of the operations of the device 3 or equipment 5 and behaviors showing each feature included in the feature group associated with the candidate trait having the same content as each of the traits.

In Step S204, the estimation part 122 calculates an execution number of a distinctive action showing a trait having the same content as the candidate trait which is included in the trait information and is extracted in Step S203 with reference to the operation history information and the behavior history information. The estimation part 122 adds the currently calculated execution number of the distinctive action showing the trait to the execution number of the distinctive action showing the trait included in the trait information stored in the user information storage part 132.

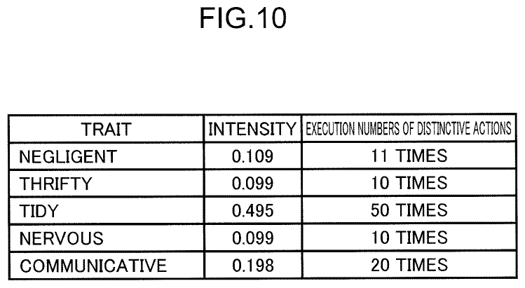

FIG. 10 is a table showing exemplary relationships between traits of the target user and execution numbers of distinctive actions showing respective traits after an update. FIG. 10 shows “11 times” that is a result obtained by the estimation part 122 in Step S204, specifically, the estimation part 122 calculates “1 time” as an execution number of the distinctive action showing the trait “negligent”, and adds the execution number of “1 time” to an execution number of the distinctive action showing the trait “negligent” included in the trait information shown in FIG. 9.

Thereafter, the estimation part 122 sets an intensity of each of the traits included in the trait information on the basis of the respective execution numbers of the distinctive actions showing the traits included in the trait information.

Specifically, the estimation part 122 sets a ratio of an execution number of the distinctive action showing each trait included in the trait information to a sum of respective execution numbers of distinctive actions associated with the traits included in the trait information as an intensity of each of the traits. Consequently, the sum of the respective intensities of the traits included in the trait information is 1 and is thus normalized.

In the example shown in FIG. 10, the sum of execution numbers of five distinctive actions showing five traits is 101 times (=11 times+10 times+50 times+10 times+20 times). Accordingly, the estimation part 122 sets the ratio “0.109 (=11 times/101 times)” of the execution number “11 times” of the distinctive action showing the trait “negligent” to the sum “101 times” as the intensity of the trait “negligent”.

Similarly, the estimation part 122 sets ratios “0.099”, “0.495”, “0.099”, “0.198” of the respective execution numbers “10 times”, “50 times”, “10 times”, and “20 times” of the distinctive actions respectively showing the traits “thrifty”, “tidy”, “nervous”, and “communicative” to the sum “101 times” of the execution numbers of the five distinctive actions showing five traits as the respective intensities of the traits “thrifty”, “tidy”, “nervous”, and “communicative”.

The way of setting the intensity of each trait is not limited thereto. For example, the estimation part 122 may set the execution number (e.g., “11 times”) of the distinctive action showing each trait (e.g., “negligent”) as the intensity of each trait.

Alternatively, in Step S204, the estimation part 122 may omit the setting of the intensity of each trait to thereby exclude the respective intensities of the traits from the trait information.

### Flow of Service Information Output Process

Hereinafter, a flow of the service information output process executed by the information processing device 1 will be described. The service information output process executes a process of determining a service to be performed to each user who is preliminarily registered as the target of the service information output process on the basis of trait information of the user which is output in the trait output process and outputting information indicative of the service.

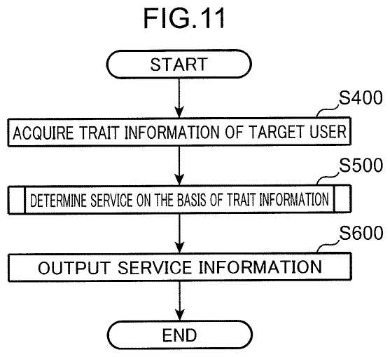

FIG. 11 is a flowchart showing an exemplary service information output process. The service information output process is executed at a predetermined period. The predetermined period means, for example, every hour, every half day, every day, every week, or every month. Hereinafter, the user who is the target of the service information output process is called as the target user.

First, in Step S400, the acquisition part 121 acquires trait information of the target user from the user information storage part 132.

Next, in Step S500, the processor 12 executes a process (hereinafter, service determination process) of determining a service to be performed to the target user on the basis of the trait information acquired in Step S400. Details on the service determination process will be described later.

Next, in Step S600, the output part 124 outputs information (hereinafter, service information) indicative of the service to be performed to the target user determined in Step S500. For example, in Step S600, the output part 124 sends (outputs) service information indicative of the service to be performed to the target user determined in Step S500 to the output device 6 used by the target user via the communication circuit 11.

However, the flow is not limited thereto, and in Step S600, the output part 124 may store in (output to) the user information storage part 132 the service information indicative of the service determined in Step S500 to be performed to the target user as the user information of the target user.

### Flow of Service Determination Process

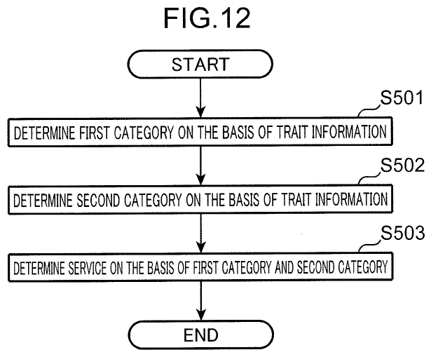

Hereinafter, details on the service determination process in Step S500 will be described. FIG. 12 is a flowchart showing an exemplary service determination process.

First, in Step S501, the determination part 123 determines a first category on the basis of traits included in the trait information acquired in Step S400. The first category includes information which is derived from a trait of the target user and serves to specify a service to be performed to the target user.

For example, the housekeeping service can be specified as a service pertaining to a service field “life (housework)”. On the other hand, since a target user having the trait “lazy” finds the housework bothersome, the target user is estimated to be prone to use a service pertaining to the service field “life (housework)”. In this manner, the service field “life (housework)” can be derived from the trait “lazy” of the target user.

As described above, information indicative of a service field can be derived from a trait of the target user and can serve to specify a service to be performed to the target user. Therefore, the information indicative of a service field may be used as the first category. Thus, hereinafter, an exemplary use of information indicative of a service field as the first category will be described.

Specifically, in Step S501, the acquisition part 121 acquires second rule information indicative of a rule for specifying the first category and the second category from the rule information storage part 135. The second category also includes information which is derived from a trait of the target user and serves to specify a service to be performed to the target user in the same manner as the first category. However, this information is presented as information that is associated with the first category but is different from the first category.

For example, the food delivery service can be specified as a service of a type “outsourcing” pertaining to a service field “diet”. On the other hand, since the target user having the trait “lazy” finds the preparation of a meal bothersome, the target user is estimated to be prone to use a service of the type “outsourcing” pertaining to the service field “diet”. In this manner, the service type “outsourcing” can be derived from the trait “lazy” of the target user and can be associated with the service field “diet”.

As described above, information indicative of a service type can be derived from a trait of the target user and can serve to specify a service to be performed to the target user. Further, information indicative of a service type can be associated with information indicative of a service field that is the first category. Therefore, the information indicative of a service type may be used as the second category. Thus, hereinafter, an exemplary use of information indicative of a service type as the second category will be described.

Namely, the second rule information is information defining a relationship among each of a plurality of constituent traits which can be included in traits of the user, a service field (first candidate category) to which each of the candidate services (hereinafter, candidate services) to be performed to the user who has traits respectively having the same contents as the constituent traits pertains, and a type (second candidate category) of each of the candidate services.

The service field to which each of the candidate services pertains includes, for example, life (general), device or equipment, life (healthcare), life (housework), life (EC), and life (diet). The type of the candidate service includes, for example, notification, prediction, suggestion, control, and outsourcing.

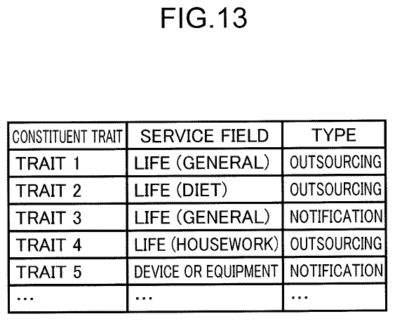

FIG. 13 is a table showing exemplary second rule information. In the second rule information shown in FIG. 13, a constituent trait “Trait 1”, the service field “life (general)”, and the type “outsourcing” are associated with one another.

The determination part 123 specifies a first trait having the greatest intensity among the traits included in the trait information acquired in Step S400. The determination part 123 determines a service field associated with the constituent trait having the same content as the first trait among the service fields included in the second rule information acquired by the acquisition part 121. The determination part 123 determines the specified service field as the first category.

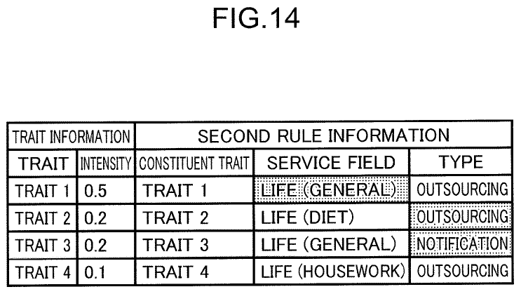

FIG. 14 is a table showing exemplary information that associates trait information with second rule information. For example, FIG. 14 shows an example where the trait information acquired in Step 400 includes four traits “Trait 1” to “Trait 4” and intensities of the respective traits, which are “0.5”, “0.2”, “0.2”, and “0.1”. Further, FIG. 14 shows an exemplary association between the trait information and a part of the second rule information shown in FIG. 13 that includes the four constituent traits “Trait 1” to “Trait 4” respectively having the same contents as the four traits “Trait 1” to “Trait 4” included in the trait information.

In this example, the determination part 123 specifies the trait “Trait 1” whose intensity “0.5” is the greatest among the intensities of the four traits included in the trait information as the first trait. The determination part 123 specifies the service field “life (general)” associated with the constituent trait “Trait 1” having the same content as the first trait among the service fields included in the second rule information as shown in a shaded field in FIG. 14. The determination part 123 determines the specified service field “life (general)” as the first category.

Next, in Step S502, the determination part 123 determines a second category associated with the first category on the basis of the traits included in the trait information acquired in Step S400.

Specifically, in Step S502, the determination part 123 determines as the second trait a trait whose intensity is next to the first trait among the traits included in the trait information acquired in Step S400. The determination part 123 specifies a candidate service type associated with a constituent trait having the same content as the second trait among the candidate service types included in the second rule information acquired by the acquisition part 121. The determination part 123 determines the specified candidate service type as the second category associated with the first category determined in Step S501.

For instance, in the example described above, the determination part 123 determines as the second trait the two traits “Trait 2” and “Trait 3”, both having the intensity next to the first trait “Trait 1” among the four traits included in the trait information (FIG. 14). The determination part 123 specifies the two candidate service types “outsourcing” and “notification” associated with two constituent traits “Trait 2” and “Trait 3” having the same contents as the second traits among the candidate service types included in the second rule information as shown in shaded fields in FIG. 14. The determination part 123 determines the two specified service types “outsourcing” and “notification” as the second categories associated with the service field “life (general)” determined as the first category in Step S501.

Alternatively, the determination part 123 may determine as the second trait a trait having an intensity different from the first trait among the traits included in the trait information acquired in Step S400. For instance, in the example described above, the determination part 123 may determine as the second traits three traits “Trait 2”, “Trait 3”, and “Trait 4, all having intensities different from the first trait “Trait 1”, among the four traits included in the trait information (FIG. 14).

Next, in Step S503, the determination part 123 determines a service to be performed to the target user on the basis of the first category determined in Step S501 and the second category determined in Step S502.

Specifically, in Step S503, the determination part 123 acquires from the rule information storage part 135 third rule information indicative of a rule for determining the service. The third rule information is information defining a relationship among a service field (one or more first categories), a candidate service type (one or more second categories), and a plurality of candidate services.

The candidate service includes various services which can be performed in the information processing device 1. For example, the candidate service includes notification of to-do list, notification of past pictures, notification of schedule of current day, alert notification of device or equipment, notification of maintenance period of device or equipment, notification of scheduled delivery date and time, notification of expenditure state of expendable part, notification of current health condition, prediction of health condition based on the current health condition, prediction of expendable part expenditure period, suggestion of life tips, automatic control to device or equipment, automatic order of expendable part.

Further, the candidate service includes various services which can be performed in an external service server 8. For example, the candidate service includes food delivery (e.g., meal, food), housekeeping service (e.g., house cleaning, meal preparation, babysitting), table reservation (e.g., means of transport, restaurant), travel reservation (e.g., means of transport, accommodation facilities, accommodation plan), and ticket reservation (e.g., movie, event, amusement facilities, amusement park).

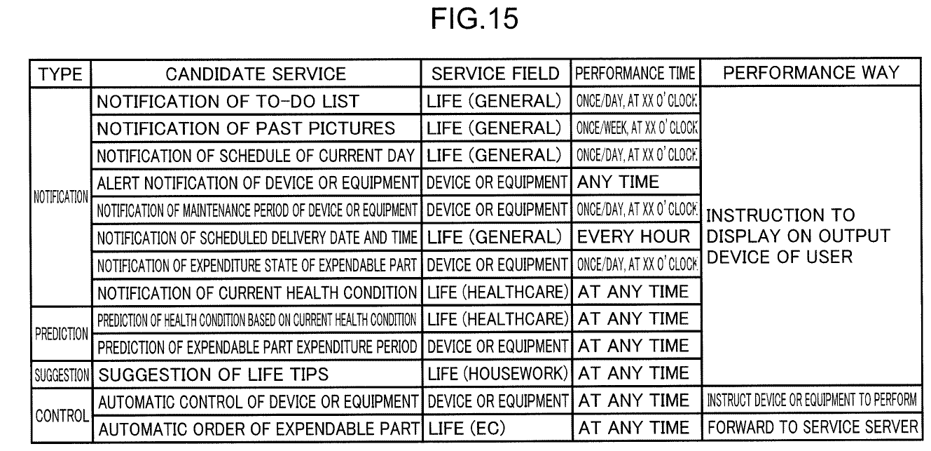

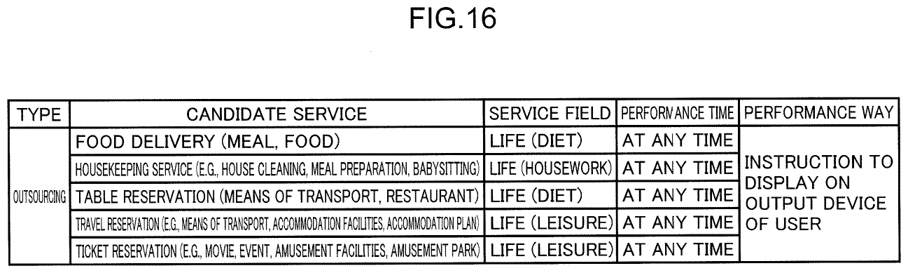

FIG. 15 is a table showing exemplary third rule information. FIG. 16 is a table showing a remaining part of the exemplary third rule information. In the third rule information shown in FIG. 15, thirteen candidate services, types of the respective candidate services, and service fields to which the respective candidate services pertain are associated with one another, and further, respective performance times of the candidate services and respective performance ways of the candidate services are associated therewith.

The performance times of the candidate services include, for example, a start time (e.g., at twelve o'clock, at any time) of the candidate service, a time interval (e.g., each hour) at which the candidate service is repeated, and the number of repetitions (e.g., three times) of the candidate service. At any time means upon acquisition of information necessary for the performance of the candidate service.

The performance way of the candidate service includes, for example, an output destination and an output instruction of information (hereinafter, output information of the candidate service) which is output through the performance of the candidate service. The output information of the candidate service includes, for example, information peculiar to the target user, e.g., to-do list, a schedule, and vital data of the user, control information of the device 3 or equipment 5, information which requests the performance of the service provided by the service server 8.

The output destination of the output information of the candidate service includes, for example, an output device 6 used by the target user, the service server 8, the device 3 or equipment 5 indicated by the output information of the candidate service. The output instruction of the output information of the candidate service includes, for example, an instruction to display output information of the candidate service, instruction to output audio, instruction to store, an instruction to forward, and an instruction to execute.

For example, in the third rule information shown in FIG. 15, the type “notification”, the candidate service “notification of to-do list”, and the service field “life (general)” are associated with one another, and further, the performance time “once/day, at XX o'clock”, and the performance way “instruction to display on output device of user” are associated therewith.

In the third rule information shown in FIG. 16, five candidate services, the type of the candidate services, and service fields to which the respective candidate services pertain are associated with one another, and further, the performance time of the candidate services and the performance way of the candidate services are associated therewith.

For example, in the third rule information shown in FIG. 16, the type “outsourcing”, the candidate service “food delivery (meal, food)”, and the service field “life (diet)” are associated with one another, and further, the performance time “at any time” and the performance way “instruction to display on output device of user” are associated therewith.

The determination part 123 specifies a candidate service associated with the first category specified in Step S501 and the second category specified in Step S502 among the candidate services included in the third rule information. The determination part 123 determines the specified candidate service as the service to be performed to the target user.

For example, there is the case as the example above where the first category specified in Step S501 includes the service field “life (general)”, and the second category specified in Step S502 includes the two service types “outsourcing” and “notification”, and the determination part 123 acquires the third rule information shown in FIG. 15 and FIG. 16.

In this case, the determination part 123 determines two candidate services “travel reservation (e.g., means of transport, accommodation facilities, accommodation plan)” and “ticket reservation (e.g., movie, event, amusement facilities, amusement park)” associated with the service field “life (leisure)” and the service type “outsourcing” in the third rule information shown in FIG. 16 as the services to be performed to the target user.

Further, the determination part 123 determines four candidate services “notification of to-do list”, “notification of past pictures”, “notification of schedule of current day”, and “notification of scheduled delivery date and time” associated with the service field “life (general)” and the service type “notification” in the third rule information shown in FIG. 15 as the services to be performed to the target user.

In this case, in Step S600 (FIG. 11), the output part 124 outputs character string information (text), e.g., “notification of to-do list”, indicative of the service determined in Step S503 as the service information. However, the output is not limited thereto, and the output part 124 may further add to the service information character string information indicative of one or more of the type, the service field, the performance time, and the performance way that are associated with the candidate service having the same content as the service determined in Step S503 with reference to the third rule information.

The configuration of this embodiment may adopt the following modifications.

(1) In the embodiment, the description is made about the example in which a first category and a second category are specified on the basis of intensities of a plurality of traits included in trait information in Step S501 (FIG. 12) and Step S502 (FIG. 12). However, a first category and a second category may be specified on the basis of the traits included in the trait information as described below.

Specifically, in Step S501, the acquisition part 121 acquires second rule information from the rule information storage part 135.

The determination part 123 calculates the number (hereinafter, first number) of traits included in the trait information that have the same content as the respective constituent traits associated with each of the one or more service fields included in the second rule information. The determination part 123 specifies a service field which has a greatest first number among the one or more service fields included in the second rule information, and determines the specified service field as the first category.

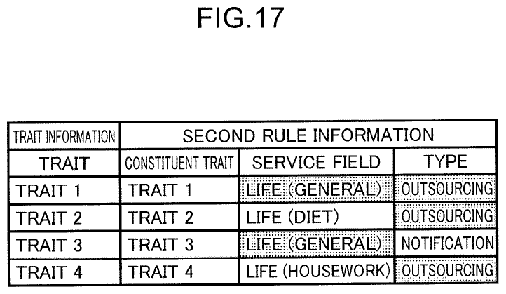

FIG. 17 is a table showing other exemplary information that associates trait information with second rule information. For example, FIG. 17 shows an example where the trait information acquired in Step S400 includes the four traits “Trait 1” to “Trait 4”. Further, FIG. 17 shows an exemplary association between the trait information and the part, including four constituent traits “Trait 1” to “Trait 4” having respectively the same contents as the four traits “Trait 1” to “Trait 4” included in the trait information, of the second rule information shown in FIG. 13.

In this example, the determination part 123 calculates the first number with respect to each of the three service fields “life (general)”, “life (diet)”, and “life (housework)” included in the second rule information. Specifically, the determination part 123 calculates the number “2” of the traits “Trait 1” and “Trait 3” which respectively have the same contents as the constituent traits “Trait 1” and “Trait 3” associated with the service field “life (general)” among the four traits “Trait 1” to “Trait 4” included in the trait information as the first number with respect to the service field “life (general)”. Similarly, the determination part 123 calculates the first number “1” with respect to the service field “life (diet)” and the service field “life (housework)”.

Subsequently, the determination part 123 specifies the service field “life (general)” which has the greatest first number “2” among the three service fields “life (general)”, “life (diet)”, and “life (housework”) included in the second rule information, and determines the specified service field “life (general)” as the first category.

In Step S502, in the same manner as in Step S501 described above, the determination part 123 calculates the number (hereinafter, second number) of traits included in the trait information that have the same content as the respective constituent traits associated with each of the one or more candidate service types included in the second rule information. The determination part 123 specifies a candidate service type which has a greatest second number among the one or more candidate service types included in the second rule information, and determines the specified candidate service type as the second category.

For example, in the example described above, the determination part 123 calculates the second number with respect to each of the two candidate service types “outsourcing” and “notification” included in the second rule information. For example, the determination part 123 calculates the number “3” of the traits “Trait 1”, “Trait 2”, and “Trait 4” which respectively have the same contents as the constituent traits “Trait 1”, “Trait 2”, and “Trait 4” associated with the candidate service type “outsourcing” among the four traits “Trait 1” to “Trait 4” included in the trait information as the second number with respect to the candidate service type “outsourcing”. Similarly, the determination part 123 calculates the second number “1” with respect to the candidate service type “notification”.

Subsequently, the determination part 123 specifies the candidate service type “outsourcing” which has the greater second number “3” of the two candidate service types “outsourcing” and “notification” included in the second rule information, and determines the specified candidate service type “outsourcing” as the second category.

(2) In the embodiment and the modification described above, the description is made about the examples in which a first category and a second category are specified using the second rule information (FIG. 13) defining a relationship among constituent traits, a service field to which each of candidate services pertain, and a type of each of the candidate services in Step S501 (FIG. 12) and Step S502 (FIG. 12). The second rule information is not limited thereto, but may be information defining a relationship between any two of: constituent traits, a service field to which each of candidate services pertain, a type of each of the candidate services, a performance time of each of the candidate services, and a performance way of each of the candidate services.

(3) In the embodiment and the modifications described above, the description is made about the examples in which a first category and a second category are specified using the second rule information in Step S501 (FIG. 12) and Step S502 (FIG. 12). However, in Step S501 (FIG. 12) and Step S502 (FIG. 12), a first category and a second category may be specified using fourth rule information as described below. Further, the Step S503 (FIG. 13) may be modified as described below.

Specifically, in Step S501, the acquisition part 121 acquires the fourth rule information indicative of a rule for specifying the first category and the second category from the rule information storage part 135. The fourth rule information is information defining a relationship among one or more first traits which can be included in traits of the user, one or more automatic controls to device 3 or equipment 5, one or more second traits which can be included in the traits of the user, and one or more fine controls included in each of the automatic controls to device 3 or equipment 5.

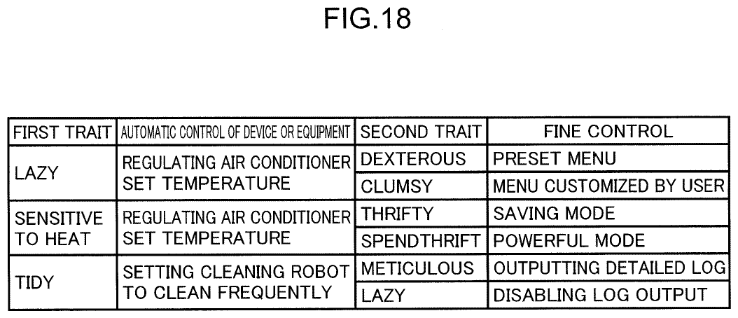

FIG. 18 is a table showing exemplary fourth rule information. In the fourth rule information shown in FIG. 18, the first trait “lazy” and an automatic control to device 3 or equipment 5 “regulating air conditioner set temperature” are associated with a second trait “dexterous” and a fine control “preset menu” included in the automatic control “regulating air conditioner set temperature”. The fine control “preset menu” included in the automatic control “regulating air conditioner set temperature” is a control of automatically regulating the set temperature of an air conditioner in accordance with a preset menu.

Further, the first trait “lazy” and the automatic control to device 3 or equipment 5 “regulating air conditioner set temperature” are associated with the second trait “clumsy” and a fine control “menu customized by user” included in the automatic control “regulating air conditioner set temperature”. The fine control “menu customized by user” included in the automatic control “regulating air conditioner set temperature” is a control of automatically regulating the set temperature of the air conditioner in accordance with a menu preliminarily customized by the user.

Further, in the fourth rule information shown in FIG. 18, the automatic control to device 3 or equipment 5 “regulating air conditioner set temperature” is also associated with the first trait “sensitive to heat”. Additionally, the first trait “sensitive to heat” and the automatic control to device 3 or equipment 5 “regulating air conditioner set temperature” are associated with the second trait “thrifty” and a fine control “saving mode” included in the automatic control “regulating air conditioner set temperature”, and are also associated with the second trait “spendthrift” and a fine control “powerful mode” included in the automatic control “regulating air conditioner set temperature”.

The fine control “saving mode” included in the automatic control “regulating air conditioner set temperature” is a control of automatically regulating the set temperature of the air conditioner in accordance with the saving mode. The fine control “powerful mode” included in the automatic control “regulating air conditioner set temperature” is a control of automatically regulating the set temperature of the air conditioner in accordance with the powerful mode.

Further, in the fourth rule information shown in FIG. 18, the first trait “tidy” is associated with the automatic control to device 3 or equipment 5 “setting cleaning robot to clean frequently”. Additionally, the first trait “tidy” and the automatic control to device 3 or equipment 5 “setting cleaning robot to clean frequently” are associated with the second trait “meticulous” and a fine control “outputting detailed log” included in the automatic control “setting cleaning robot to clean frequently” and are also associated with the second trait “lazy” and a fine control “disabling log output” included in the automatic control “setting cleaning robot to clean frequently”.

The fine control “outputting detailed log” included in the automatic control “setting cleaning robot to clean frequently” is a control of setting a cleaning robot to clean frequently and to also output detailed log information concerning the cleaning operation. The fine control “disabling log output” included in the automatic control “setting cleaning robot to clean frequently” is a control of setting a cleaning robot to clean frequently but not to output the log information concerning the cleaning operation.

The determination part 123 specifies a first trait having the same content as each of the traits included in the trait information acquired in Step S400 (FIG. 11) among one or more first traits included in the fourth rule information acquired by the acquisition part 121. Thereafter, the determination part 123 specifies an automatic control to device 3 or equipment 5 associated with the specified first trait among the one or more automatic controls to device 3 or equipment 5 included in the fourth rule information. The determination part 123 determines the specified automatic control to device 3 or equipment 5 as the first category.

For example, there is a case that the trait information acquired in Step S400 (FIG. 11) includes two traits “lazy” and “dexterous” and the acquisition part 121 acquires the fourth rule information shown in FIG. 18.

In this case, the determination part 123 specifies the first trait “lazy” having the same content as one of the two traits “lazy” and “dexterous” included in the trait information among three first traits “lazy”, “sensitive to heat”, and “tidy” included in the fourth rule information. Thereafter, the determination part 123 specifies the automatic control to device 3 or equipment 5 “regulating air conditioner set temperature” associated with the specified first trait “lazy” out of the two automatic controls to device 3 or equipment 5 “regulating air conditioner set temperature” and “setting cleaning robot to clean frequently” included in the fourth rule information. The determination part 123 determines the specified automatic control to device 3 or equipment 5 “regulating air conditioner set temperature” as the first category.

In Step S502 (FIG. 12), the determination part 123 specifies a second trait that is associated with the automatic control to device 3 or equipment 5 determined as the first category in Step S501 and has the same as each of the traits included in the trait information acquired in Step S400 (FIG. 11) among the one or more second traits included in the fourth rule information acquired by the acquisition part 121. Thereafter, the determination part 123 specifies a fine control associated with the specified second trait among the one or more fine controls included in each of the automatic controls to device 3 or equipment 5 included in the fourth rule information. The determination part 123 determines the specified fine control as the second category.

For example, in the example described above, the determination part 123 specifies the second trait “dexterous” that is associated with the automatic control to device 3 or equipment 5 “regulating air conditioner set temperature” determined as the first category in Step S501 and has the same as one of the two traits “lazy” and “dexterous” included in the trait information acquired in Step S400 (FIG. 11) among six second traits “dexterous”, “clumsy”, “thrifty”, “spendthrift”, “meticulous”, and “lazy” included in the fourth rule information (FIG. 18). Thereafter, the determination part 123 specifies the fine control “preset menu” associated with the specified second trait “dexterous” among six fine controls included in the automatic controls to device 3 or equipment 5 included in the fourth rule information. The determination part 123 determines the specified fine control “preset menu” as the second category.

In Step S503 (FIG. 12), the determination part 123 determines an automatic control service of performing the fine control indicated by the second category which is determined in Step S502 (FIG. 12) and is included in the automatic control to device 3 or equipment 5 indicated by the first category determined in Step S501 (FIG. 12) as the service to be performed to the user.

In the example described above, the determination part 123 determines the automatic control service of performing the fine control “preset menu” indicated by the second category included in the automatic control to device 3 or equipment 5 “regulating air conditioner set temperature” indicated by the first category as the service to be performed to the user.

(4) There is a case that, in the configurations of the embodiment and the modifications described above, a trait output process (FIG. 3) is performed by treating as the target user each of the first user and the second user who are preliminarily registered as the targets of the respective service information output processes, and thereafter, when the first user and the second user are in a common space 40, a service information output process is performed by treating as the target user each of the first user and the second user. In this case, a multiset of the services determined as services to be performed to the respective target users is liable to include two or more conflicting services.

For example, the service “automatic control to device or equipment” is determined as the service to be performed to the first user on the basis of the trait “sensitive to heat” of the first user. The service “automatic control to device or equipment” is a service of performing an automatic control to a device 3 or equipment 5 provided in the space 40 where the user is present according to a trait of the user. Similarly, the service “automatic control to device or equipment” is determined as the service to be performed to the second user on the basis of the trait “sensitive to cold” of the second user.

In this case, when the service “automatic control to device or equipment” to be performed to the first user is performed, control information of establishing the set temperature of an air conditioner in the space 40 where the first user is present to “25 degrees” is output to the air conditioner according to the trait “sensitive to heat” of the first user. On the other hand, when the service “automatic control to device or equipment” to be performed to the second user is performed, control information of establishing the set temperature of the air conditioner in the space 40 where the second user is present to “27 degrees” is output to the air conditioner according to the trait “sensitive to cold” of the second user. As a result, the set temperatures which are parameters used for automatic control to the air conditioner in the space 40 where the first user and the second user are present are in conflict with each other.

Here, as described above, when the first user and the second user are in the common environment, the service information output process is performed by treating each of the first user and the second user as the target user, and the multiset of the services determined in Step S503 (FIG. 12) includes two or more conflicting services. In this case, as described below, the output part 124 may output service information indicative of a service which enables the avoidance of the conflict in Step S600 (FIG. 11).

In particular, in Step S600 (FIG. 11), the output part 124 firstly determines whether the first user and the second user are in a common environment or not.

Specifically, the output part 124 acquires the sensor information including the detection information concerning the space 40 where the first user is present from the sensor information storage part 134 with reference to the reference data including a user ID of the first user stored in the user information storage part 132. The output part 124 acquires a piece of sensor information including the latest detection date and time among the acquired sensor information as information (hereinafter, first behavior information) indicative of a behavior of the first user in the space 40 where the first user is currently present. Similarly, the output part 124 acquires information (hereinafter, second behavior information) indicative of a behavior of the second user in the space 40 where the second user is currently present.

The output part 124 determines, with reference to the device information stored in the device information storage part 131, whether the space 40 provided with a sensor 7 whose sensor ID is included in the first behavior information and the space 40 provided with a sensor 7 whose sensor ID is included in the second behavior information are the same space. When it is determined that these are the same space, the output part 124 determines that the first user and the second user are in the common environment, and when determining that these are not the same space, the output part 124 determines that the first user and the second user are not in the common environment.

When it is determined that the first user and the second user are not in the common environment, the output part 124 performs the Step S600 (FIG. 11) by treating each of the first user and the second user as the target user.

On the other hand, when it is determined that the first user and the second user are in the common environment, the output part 124 acquires fifth rule information from the rule information storage part 135. The fifth rule information is information defining a relationship among one or more conflicting service groups each including two or more conflicting services and a plurality of avoidance manners for avoiding the conflicts between the two or more conflicting services included in each of the conflicting service groups.

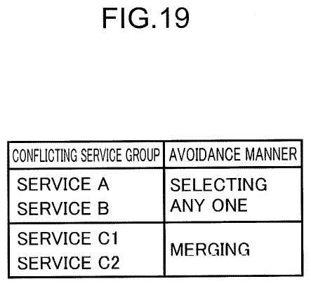

FIG. 19 is a table showing exemplary fifth rule information. In the fifth rule information shown in FIG. 19, two conflicting service groups are associated with two avoidance manners. For example, in the fifth rule information shown in FIG. 19, a conflicting service group including two conflicting services “Service A” and “Service B” is associated with an avoidance manner “selecting any one” for avoiding the conflicts between the two conflicting services “Service A” and “Service B” included in the conflicting service group. The avoidance manner “selecting any one” means selecting any one of the two or more conflicting services included in the conflicting service group. Hereinafter, the avoidance manner “selecting any one” is called as a first manner.

Further, in the fifth rule information shown in FIG. 19, a conflicting service group including two conflicting services “Service C1” and “Service C2” is associated with an avoidance manner “merging” for avoiding the conflicts between the two conflicting services “Service C1” and “Service C2” included in the conflicting service group. The avoidance manner “merging” means merging two or more conflicting services included in a conflicting service group. Hereinafter, the avoidance manner “merging” is called as a second manner.

The output part 124 determines whether the multiset of services determined for the first user and the second user includes a service group having the same content as the conflicting service group with reference to the fifth rule information. When it is determined that the service group having the same content as the conflicting service group is included, the output part 124 extracts the service group from the multiset of services.

For example, in a case that the multiset of services determined for the first user and the second user includes four services “Service A”, “Service B”, “Service C”, and “Service D”, and the output part 124 acquires the fifth rule information shown in FIG. 19, the output part 124 extracts from the multiset of services a service group including the two services “Service A” and “Service B” having the same content as the conflicting service group including the two conflicting services “Service A” and “Service B”.

When it is determined that no service group having the same content as the conflicting service group is included, the output part 124 performs the Step S600 (FIG. 11) by treating each of the first user and the second user as the target user as described above.

There is a case that a multiset of services includes not only a service group having the same content as a conflicting service group but also a service group different from this service group. In this case, the output part 124 outputs service information indicative of each of services (in the example described above, “Service C1” and “Service C2”) included in the different service group in the same manner as in Step S600 (FIG. 11) to an output device 6 used by the first user or the second user to whom each of the services is provided.

When a service group having the same content as a conflicting service group is extracted, the output part 124 determines which an avoidance manner (hereinafter, target avoidance manner) associated with the conflicting service group having the same as the service group is the first manner or the second manner with reference to the fifth rule information.

In the example described above, in the fifth rule information (FIG. 19), the conflicting service group including the two conflicting services “Service A” and “Service B” having the same content as the service group extracted by the output part 124 is associated with the avoidance manner “selecting any one” (the first manner). Therefore, the output part 124 determines that the target avoidance manner is the first manner.

When it is determined that the target avoidance manner is the first manner, the output part 124 acquires an intensity of the first trait of the user to whom each of the two or more services included in the extracted service group is provided.

In the example described above, the service group extracted by the output part 124 includes the two services “Service A” and “Service B”. Therefore, the output part 124 acquires an intensity of the first trait of the first user or the second user whom the service “Service A” is provided to, that is, the greatest intensity among the intensities of a plurality of traits of the first user or the second user. Similarly, the output part 124 acquires an intensity of the first trait of the first user or the second user to whom the service “Service B” is provided.

Thereafter, the output part 124 selects one service of the two or more services on the basis of the intensity of the first trait acquired about each of the two or more services included in the extracted service group.

Specifically, the output part 124 selects a service about which the greatest intensity of the first trait is acquired among the two or more services included in the extracted service group as the one service. The output part 124 outputs information indicative of the selected one service as the service information.

In a case that, in the example described above, the output part 124 acquires “0.5” as the intensity of the first trait about the service “Service A” and “0.3” as the intensity of the first trait about the service “Service B”, the output part 124 selects the service “Service A” about which the greater intensity “0.5” of the first trait is acquired of the two services “Service A” and “Service B” included in the extracted service group as the one service.

The output part 124 may select the one service in a predetermined manner different from the selection of a service provided to the first trait having the greatest intensity, and may select, for example, a service provided to the first trait having the smallest intensity among the two or more services included in the extracted service group.

Thereafter, in the same manner as in the Step S600 (FIG. 11) described above, the output part 124 outputs information indicative of the selected one service as the service information.

On the other hand, when it is determined that the target avoidance manner is the second manner, the output part 124 acquires an intensity of the second trait of the user to whom each of the two or more services included in the extracted service group is provided.

For example, there is a case that the service group extracted by the output part 124 includes the two services “Service C1” and “Service C2”, and the output part 124 thus determines that the target avoidance manner is the second manner (avoidance manner “merging”) with reference to the fifth rule information shown in FIG. 19.

In this case, the output part 124 acquires the intensity of a second trait of the first user or the second user whom the service “Service C1” is provided to, that is, the intensity next to the greatest intensity among the intensities of the traits of the first user or the second user. Further, the output part 124 acquires the intensity of a second trait of the first user or the second user whom the service “Service C2” is provided to, that is, the intensity next to the greatest intensity among the intensities of the traits of the first user or the second user.

Thereafter, the output part 124 merges the two or more services on the basis of the intensity of the second trait acquired about each of the two or more services included in the extracted service group. Hereinafter, the service resulting from the merger of the two or more services is called as the merged service.

Specifically, the output part 124 calculates a difference between intensities of any two of the second traits among the intensities of the second traits acquired about each of the two or more services included in the extracted service group. For example, the output part 124 calculates a difference between the greatest intensity of the second trait and the smallest intensity of the second trait among the intensities of the second traits acquired about each of the two or more services included in the extracted service group.

In a case that the calculated difference is smaller than a predetermined value, the output part 124 merges the two or more services by averaging conflicting parameters among the two or more services. On the other hand, in a case that the calculated difference is equal to or greater than the predetermined value, the output part 124 determines a service which is provided to the second trait having the greatest intensity as the merged service.

There is a case that, in the example described above, the output part 124 acquires “0.5” as the intensity of the second trait about the service “Service C1” and “0.3” as the intensity of the second trait about the service “Service C2”, and the predetermined value is “0.3”.

In this case, the output part 124 calculates a difference “0.2” between the intensity “0.5” of the second trait acquired about the service “Service C1” and the intensity “0.3” of the second trait acquired about the service “Service C2”. Since the calculated difference “0.2” is smaller than the predetermined value “0.3”, the output part 124 merges the two or more services by averaging the conflicting parameters between the two services “Service C1” and “Service C2”.

For example, in a case where the service “Service C1” is a service of automatically establishing the set temperature of the air conditioner to “25 degrees” and the service “Service C2” is a service of automatically establishing the set temperature of the air conditioner to “27 degrees”, the output part 124 merges the two services “Service C1” and “Service C2” by obtaining an average of “26 degrees=(25 degrees+27 degrees/2)” of the set temperatures of the air conditioner which are the conflicting parameters of the two services. In other words, the merged service resulting from the merger of the two or more services provides a service of automatically establishing the set temperature of the air conditioner to “26 degrees”.

On the other hand, in a case where the predetermined value is “0.2”, since the calculated difference “0.2” is equal to or greater than the predetermined value “0.2”, the output part 124 determines as the merged service the service “Service C1” provided to the second trait having the greater intensity “0.5” of the two services “Service C1” and “Service C2”.

Further, in the same manner as in the Step S600 (FIG. 11) described above, the output part 124 outputs the information indicative of the merged service as the service information.

In the configuration of this modification (4), it may be further appreciated to store in the memory 13 a priority level assigned to each of the candidate services included in the third rule information (FIG. 15, FIG. 16) by each of one or more users preliminarily registered as the target of a service information output process.

Further, as described below, it may be appreciated that the output part 124 specifies, when extracting a service group having the same content as a conflicting service group, a service which serves to avoid a conflict between the two or more services included in the service group on the basis of the priority level as described above. Further, the output part 124 may output information indicative of the specified service as the service information.

Specifically, in a case that the output part 124 extracts a service group having the same content as a conflicting service group from a multiset of services which are determined for the first user and the second user, the output part 124 acquires from the memory 13 a priority level assigned to each of the candidate services included in the third rule information (FIG. 15, FIG. 16) by each of one or more of the first user and the second user.

The output part 124 determines whether a priority level is assigned to each candidate service having the same content as each of the two or more services included in the extracted service group by the user to whom each of the services is provided.

For example, there is a case that a service included in the service group extracted by the output part 124 is a service determined to be performed to the first user. In other words, the user whom the service is provided to is the first user.

In this case, if a priority level assigned by the first user to a candidate service having the same content as the service is acquired from the memory 13, the output part 124 determines that the priority level is assigned to the candidate service having the same content as the service by the user whom the service is provided to. On the other hand, if no priority level assigned by the first user to the candidate service having the same content as the service is acquired from the memory 13, the output part 124 determines that no priority level is assigned to the candidate service having the same content as the service by the user whom the service is provided to.

Similarly, in a case that the service included in the extracted service group is provided to the second user, the output part 124 determines whether a priority level is assigned to a candidate service having the same content as the service by the user to whom the service is provided.

In a case that the output part 124 determines that the priority level is assigned to each candidate service having the same content as one or more services among the two or more services included in the extracted service group by the user whom each of the services is provided to, the output part 124 specifies the service to which the highest priority level is assigned among the one or more services. Thereafter, the output part 124 outputs information indicative of the specified service as the service information in the same manner as in the Step S600 (FIG. 11) described above.

On the other hand, in a case that the output part 124 determines that no priority level is assigned to any of the two or more services included in the extracted service group by the user whom each of the services is provided to, the output part 124 determines which of the first manner and the second manner the target avoidance manner is with reference to the fifth rule information (FIG. 19) as described above, and outputs service information indicative of a service which serves to avoid a conflict between the two or more services in accordance with a result of the determination.

(5) In the configuration of the modification (1) described above, a trait output process (FIG. 3) is performed by treating as the target user each of the first user and the second user who are preliminarily registered as the target of a service information output process, and thereafter, when the first user and the second user are in a common space 40, a service information output process (FIG. 11) is performed by treating as the target user each of the first user and the second user.

When the first user and the second user are in a common space 40, the Step S400 (FIG. 11) may be performed by treating as the target user each of the first user and the second user. The determination as to whether the first user and the second user are in the common space 40 may be performed in the same manner as in the modification (4) described above.

In this case, information indicative of a multiset of a plurality of traits included in the respective trait information of the first user and the second user which are acquired in the Step S400 may be treated as trait information of a single user who is present in the space 40 where the first user and the second user are present. Thereafter, the Step S500 (FIG. 11) and the Step S600 (FIG. 11) may be performed by treating the single user as the target user.

(6) In the configurations of the embodiment and the modifications described above, it may be appreciated to further store sixth rule information defining a relationship between a plurality of constituent traits and one or more spaces 40 in the rule information storage part 135.

For example, in the sixth rule information, the constituent trait “sensitive to heat” and a space ID of a space 40 provided with an air conditioner frequently used by the user having the trait “sensitive to heat” having the same content as the constituent trait are associated with each other. Further, in the sixth rule information, the constituent trait “lazy” and a space ID of a space 40 occupied for a long time by the user who has the trait “lazy” having the same content as the constituent trait are associated with each other.

Further, as described below, the traits of the target user used for specifying the first category and the second category may be restricted according to a space (environment) 40 where the target user is currently present using the sixth rule information.

Specifically, in Step S501 (FIG. 12), the acquisition part 121 further acquires the sixth rule information in addition to the second rule information from the rule information storage part 135. Further, the acquisition part 121 acquires information (hereinafter, environment information) indicative of the space 40 where the target user is currently present.

Specifically, the acquisition part 121 acquires the sensor information including the detection information concerning the space 40 where the target user is present from the sensor information storage part 134 with reference to the reference data including a user ID of the target user stored in the user information storage part 132. The output part 124 acquires a piece of sensor information including the latest detection date and time among the acquired sensor information as information (hereinafter, behavior information) indicative of the behavior of the target user in the space 40 where the target user is currently present. The acquisition part 121 acquires as environment information a space ID of a space 40 provided with a sensor 7 whose sensor ID is included in the behavior information with reference to the device information stored in the device information storage part 131.

The acquisition part 121 further acquires one or more constituent traits associated with the space 40 indicated by the environment information from the sixth rule information.

Thereafter, in the Step S501 (FIG. 12), the determination part 123 determines a first category on the basis of one or more traits having the same content as one or more constituent traits acquired by the acquisition part 121 from the sixth rule information among the traits, in place of the determination based on traits included in the trait information of the target user acquired in Step S400 (FIG. 11).

Similarly, in Step S502 (FIG. 12), the determination part 123 determines a second category on the basis of one or more traits having the same content as the one or more constituent traits acquired by the acquisition part 121 from the sixth rule information among the traits, in place of the determination based on the traits included in the trait information of the target user acquired in Step S400 (FIG. 11).

(7) In Step S600 (FIG. 11) in the configurations of the embodiment and the modifications, it may be appreciated that the output part 124 outputs request information requesting to send back information indicative of use or non-use of the service indicated by the service information together with the service information to an output device 6 used by the target user. Further, it may be appreciated to re-execute the service determination process (FIG. 12) and re-execute the Step S600 (FIG. 11) when the information indicative of the non-use of the service is returned from the output device 6.

In Step S502 (FIG. 12) in the re-execution of the service determination process (FIG. 12), the determination part 123 may determine as the second trait the trait whose intensity is next to the second trait determined in the previous service determination process among the traits included in the trait information. The service determined as the service to be performed to the target user in the service determination process in the re-execution may be thus as different as possible from the service determined in the previous service determination process.

(8) In Step S600 (FIG. 11) in the configuration of the modification (7) described above, it may be appreciated that the output part 124 further outputs to the output device 6 used by the target user information (permission-denial request information) requesting to send back information indicative of permission or denial of a succeeding output of the service information. Further, when the information indicative of the non-use of the service is returned from the output device 6, until the information indicative of the denial of the succeeding output of the service information is returned from the output device 6, the service determination process (FIG. 12) may be re-executed, and the Step S600 (FIG. 11) may be re-executed. In this case, the service information output process may end when the information indicative of the denial of the succeeding output of the service information is returned from the output device 6.

(9) In the configurations of the embodiment and the modifications, it may be appreciated to further store information indicative of a plurality of services used by the user in the past (hereinafter, used services) in the user information storage part 132. Further, the output part 124 may output information suggesting a suspension of the use of one or more used services used by the target user in the past to the output device 6 used by the target user as described below.

Specifically, in Step S600 (FIG. 11), the output part 124 acquires information indicative of the used services used by the target user in the past from the user information storage part 132. The output part 124 calculates, with reference to the third rule information (FIG. 15, FIG. 16) stored in the rule information storage part 135, the number of used services (hereinafter, specific used services) having the same contents as the candidate services associated with the first category determined in Step S501 (FIG. 12) among the used services.

In a case that the number of the specific used services is not less than a certain number, the output part 124 outputs the information suggesting a suspension of the use of the specific used service together with the service information to the output device 6 used by the target user.

Alternatively, information indicative of a plurality of used services and respective use frequencies of the used services may be stored in the user information storage part 132 in association with each other.

Further, in Step S600 (FIG. 11), the output part 124 may acquire the information indicative of the used services used by the target user in the past and the respective use frequencies of the used services from the user information storage part 132. Further, the output part 124 may calculate the number of specific used services in the same manner as the above.

In this case, if the number of the specific used services is not less than a certain number, the output part 124 may output information which suggests suspending the use of a specific used service having the lowest use frequency among the certain number or more of specific used services and using the service indicated by the service information together with the service information to the output device 6 used by the target user.

(10) In Step S500 (FIG. 11) in the configurations of the embodiment and the modifications described above, in place of performing the service determination process shown in FIG. 12, the determination part 123 may determine the service to be performed to the target user on the basis of the traits included in the trait information of the target user acquired in Step S400 (FIG. 11). This process may be implemented, for example, in the following manner.

Specifically, seventh rule information associating one or more constituent trait groups each including a plurality of constituent traits with one or more candidate services is stored in the rule information storage part 135. In Step S500 (FIG. 11), the determination part 123 determines, with reference to the seventh rule information, a candidate service associated with a constituent trait group including the constituent traits having the same content as the traits included in the trait information of the target user acquired in Step S400 (FIG. 11) as the service to be performed to the target user.

In this disclosure, the embodiment, and the modifications (1) to (10) may be optionally combined.

The present disclosure is useful in providing a service suitable to a plurality of traits of a user which is estimated on the basis of a device operation or a behavior of the user.

1. An information processing method by a computer, comprising:
acquiring action information indicative of at least one of a device operation and a behavior of a user;
estimating a plurality of traits of the user on the basis of the action information;
determining a service to be performed to the user on the basis of the traits; and
outputting service information indicative of the service.

2. The information processing method according to claim 1, wherein,
in the determination of the service,
a first category for specifying the service is determined on the basis of the traits,
a second category associated with the first category is determined on the basis of the traits, and
the service is determined on the basis of the first category and the second category.

3. The information processing method according to claim 2, further comprising:
acquiring information defining a relationship among a plurality of constituent traits, one or more first candidate categories, and one or more second candidate categories, wherein,
in the determination of the first category,
a first number denoting the number of traits that have the same content as the respective constituent traits with respect to each of the one or more first candidate categories is calculated,
a first candidate category which has a greatest first number is specified among the one or more first candidate categories, and the specified first candidate category is determined as the first category,
in the determination of the second category,
a second number denoting the number of traits that have the same content as the respective constituent traits with respect to each of the one or more second candidate categories is calculated,
a second candidate category which has a greatest second number is specified among the one or more second candidate categories, and the specified second candidate category is determined as the second category,
in the determination of the service,
rule information defining a relationship among one or more first categories, one or more second categories, and a plurality of candidate services is acquired, and
the candidate service associated with the first category and the second category is specified among the candidate services, and the specified candidate service is determined as the service.

4. The information processing method according to claim 2, further comprising:
calculating an intensity of each of the traits on the basis of the action information; and
acquiring information defining a relationship among a plurality of constituent traits, one or more first candidate categories, and one or more second candidate categories, wherein,
in the determination of the first category,
a first trait having the greatest intensity is specified among the traits, the first candidate category associated with the constituent trait having the same content as the first trait is specified among the one or more first candidate categories, and the specified first candidate category is determined as the first category,
in the determination of the second category,
the trait whose intensity is next to the first trait among the traits is determined as the second trait, the second candidate category associated with the constituent trait having the same content as the second trait is specified among the one or more second candidate categories, and the specified second candidate category is determined as the second category,
in the determination of the service,
rule information defining a relationship among one or more first categories, one or more second categories, and a plurality of candidate services is acquired, and
the candidate service associated with the first category and the second category is specified among the candidate services, and the specified candidate service is determined as the service.

5. The information processing method according to claim 3, wherein
the one or more first categories include any one of a service field to which each of the candidate services pertain, a type of each of the candidate services, a performance time of each of the candidate services, and a performance way of each of the candidate services, and
the one or more second categories include any one of the service field, the type, the performance time, and the performance way that is different from the one or more first categories.

6. The information processing method according to claim 2, further comprising:
calculating respective intensities of the traits on the basis of the action information;
acquiring information defining a relationship among one or more first traits, one or more device automatic controls, one or more second traits, and one or more fine controls included in each of the device automatic controls, wherein,
in the determination of the first category,
the first trait having the same content as each of the traits is specified among the one or more first traits,
the device automatic control associated with the specified first trait is specified among the one or more device automatic controls, and the specified device automatic control is determined as the first category,
in the determination of the second category,
the second trait that is associated with the device automatic control determined as the first category and has the same as each of the traits is specified among the one or more second traits,
the fine control associated with the specified second trait is specified among the one or more fine controls, and the specified fine control is determined as the second category, and
in the determination of the service,
an automatic control service of performing the fine control indicated by the second category included in the device automatic control indicated by the first category is determined as the service.

7. The information processing method according to claim 3, wherein
the user includes a first user and a second user,
in a case that the first user and the second user are in a common environment,
the acquisition of the action information and the estimation of the traits are respectively executed about each of the first user and the second user,
the first category and the second category are determined using a multiset of the traits estimated about the first user and the second user as the traits estimated about the user, and
the determination of the service and the output of the service information are executed.

8. The information processing method according to claim 4, wherein
the user includes a first user and a second user,
in a case that the first user and the second user are in a common environment,
the acquisition of the action information, the estimation of the traits, the calculation of intensities of the respective traits, the determination of the first category, the determination of the second category, and the determination of the service are respectively executed about the first user and the second user,
further comprising:
acquiring information defining a relationship among one or more conflicting service groups each including two or more conflicting services and a plurality of avoidance manners for avoiding the conflicts,
the avoidance manners including a first manner of selecting one of the two or more conflicting services and a second manner of merging the two or more conflicting services;
extracting, when a multiset of the services determined for the first user and the second user includes a service group having the same content as the conflicting service group, the service group from the multiset;
determining which a target avoidance manner that is an avoidance manner associated with the conflicting service group having the same as the service group is the first manner or the second manner;
in a case that the target avoidance manner is the first manner,
acquiring an intensity of the first trait of the user whom each of the two or more services included in the service group is provided to;
selecting one service of the two or more services on the basis of the intensity of the first trait acquired about each of the two or more services, and outputting information indicative of the one service as the service information;
in a case that the target avoidance manner is the second manner,
acquiring an intensity of the second trait of the user whom each of the two or more services is provided to; and
merging the two or more services on the basis of the intensity of the second trait acquired about each of the two or more services, and outputting information indicative of the merged service as the service information.

9. The information processing method according to claim 8, wherein,
in the case that the target avoidance manner is the first manner,
in the selection of the one service, the service which is provided to the first trait having the greatest intensity is selected among the two or more services as the one service.

10. The information processing method according to claim 8, wherein,
in the case that the target avoidance manner is the second manner,
in the merger of the two or more services,
a difference between intensities of any two of the second traits among the intensities of the second traits provided with the two or more services is calculated, and
in a case that the difference is smaller than a predetermined value, the two or more services are merged as the merged service by averaging conflicting parameters among the two or more services, and
in a case that the difference is equal to or greater than the predetermined value, the service which is provided to the second trait having the greatest intensity is determined as the merged service.

11. The information processing method according to claim 8, further comprising, in a case that the service group is extracted,
acquiring a priority level assigned to each of the candidate services by each of one or more of the first user and the second user;
determining whether the priority level is assigned to each candidate service being included in the candidate services and having the same content as each of the two or more services by the user whom each of the services is provided to; and
specifying the service to which the highest priority level is assigned among one or more services when the priority level is determined to be assigned to the one or more services among the two or more services, and outputting the service information indicative of the specified service.

12. The information processing method according to claim 3, further comprising:
acquiring information defining a relationship between the constituent traits and one or more environments;
acquiring environment information indicative of an environment where the user is currently present; and
acquiring one or more constituent traits associated with the environment indicated by the environment information among the one or more environments from the constituent traits, wherein,
in the determination of the first category and the second category,
one or more traits having the same content as the one or more constituent traits among the traits are used in place of the traits.

13. The information processing method according to claim 4, wherein,
in the output of the service information,
request information requesting the user to send back information indicative of use or non-use of the service indicated by the service information is output together with the service information to an output device used by the user,
the determination of the first category, the determination of the second category, the determination of the service, and the output of the service information are re-executed when the information indicative of the non-use of the service is returned from the output device, and
at the specification of the second trait in the determination of the second category during the re-execution, the trait whose intensity is next to the second trait among the traits is determined as the second trait.

14. The information processing method according to claim 13, wherein,
in the output of the service information,
permission-denial request information requesting the user to send back information indicative of permission or denial of a succeeding output of the service information is further output to the output device, and
when the information indicative of the non-use of the service is returned from the output device until the information indicative of the denial of the succeeding output of the service information is returned from the output device, the determination of the first category, the determination of the second category, the determination of the service, and the output of the service information are re-executed.

15. The information processing method according to claim 3, further comprising:
acquiring information indicative of a plurality of used services used by the user in the past, wherein,
in the output of the service information,
the number of specific used services which are the used services having the same content as the candidate services associated with the determined first category in the rule information among the used services is further calculated, and
in a case that the number of the specific used services is not less than a certain number, information suggesting a suspension of the use of the specific used service is output together with the service information to an output device used by the user.

16. The information processing method according to claim 3, further comprising:
acquiring information indicative of a plurality of used services used by the user in the past and respective use frequencies of the used services, wherein,
in the output of the service information,
the number of specific used services which are the used services having the same content as the candidate services associated with the determined first category in the rule information among the used services is further calculated, and
in a case that the number of the specific used services is not less than a certain number, information which suggests suspending the use of a specific used service having the lowest use frequency among the certain number or more of specific used services and using the service indicated by the service information is output together with the service information to an output device used by the user.

17. An information processing device, comprising:
an acquisition part that acquires action information indicative of at least one of a device operation and a behavior of a user;
an estimation part that estimates a plurality of traits of the user on the basis of the action information;
a determination part that determines a service to be performed to the user on the basis of the traits; and
an output part that outputs service information indicative of the service.

18. The information processing device according to claim 17, wherein
the determination part:
determines a first category for specifying the service on the basis of the traits,
determines a second category associated with the first category on the basis of the traits, and
determines the service on the basis of the first category and the second category.

19. A non-transitory computer readable storage medium storing a program causing a computer to function as:
an acquisition part that acquires action information indicative of at least one of a device operation and a behavior of a user;
an estimation part that estimates a plurality of traits of the user on the basis of the action information;
a determination part that determines a service to be performed to the user on the basis of the traits; and
an output part that outputs service information indicative of the service.

20. The non-transitory computer readable storage medium according to claim 19, wherein
the determination part:
determines a first category for specifying the service on the basis of the traits,
determines a second category associated with the first category on the basis of the traits, and
determines the service on the basis of the first category and the second category.
